(19) United States
(12) Patent Application Publication
(10) Pub. No.: US 2021/0152249 A1
(43) Pub. Date: May 20, 2021

(54) PASSIVE OPTICAL NETWORK (PON) CHANNEL BONDING PROTOCOL

(71) Applicant: Huawei Technologies Co., Ltd., Shenzhen (CN)

(72) Inventors: Bo Gao, Wuhan (CN); Yuanqiu Luo, Cranbury, NJ (US); Frank Effenberger, Frisco, TX (US)

(21) Appl. No.: 17/158,807

(22) Filed: Jan. 26, 2021

Related U.S. Application Data
(63) Continuation of application No. PCT/CN2019/091251, filed on Jun. 14, 2019.
(60) Provisional application No. 62/734,621, filed on Sep. 21, 2018.

(51) Int. Cl. H04B 10/40; H04B 10/27; H04B 10/50; H04B 10/60

(52) U.S. Cl. CPC H04B 10/40; H04B 10/60; H04B 10/50; H04B 10/27

(57) ABSTRACT

An Optical Line Terminal (OLT) includes a downstream transceiver coupled to a Passive Optical Network (PON). The downstream transceiver is configured to communicate over a plurality of bonded channels. The OLT also includes an upstream transceiver configured to receive a downstream Service Data Unit (SDU) including user data. A processor is coupled to the upstream transceiver. The processor is configured to split the downstream SDU into a plurality of downstream blocks. The processor distributes the plurality of downstream blocks amongst selected bonded channels based on bonded channel availability for transmission over the PON via the downstream transceiver.

### CROSS-REFERENCE TO RELATED APPLICATIONS

This patent application is a continuation of International Application No. PCT/CN2019/091251, filed Jun. 14, 2019, by Bo Gao, et. al., and titled “Passive Optical Network (PON) Channel Bonding Protocol,” which claims the benefit of U.S. Provisional Patent Application No. 62/734,621, filed Sep. 21, 2018, by Bo Gao, et. al., and titled “Passive Optical Network (PON) Channel Bonding Protocol,” which are hereby incorporated by reference.

### TECHNICAL FIELD

The present disclosure is generally related to Passive Optical Networks (PONs), and is specifically related to bonding wavelength based channels in a PON and communication over such bonded channels.

### BACKGROUND

A PON is one system for providing network access between the edge of a service provider's network and the end consumer. The PON is a point-to-multipoint (P2MP) network employing an upstream optical device at the central office, an optical distribution network (ODN) of passive optical components, and a plurality of downstream optical devices at the customer premises. Various PON systems have been developed including Gigabit PONs (GPONs) and Ethernet PONs (EPONs), which have been deployed worldwide for multimedia applications. User bandwidth demands are ever increasing, and fifty gigabits per second (50G) PONs are currently under development to meet such demands. Some PONs may operate by employing a single communication channel that is shared between PON devices by employing time division multiplexing. However, achieving a 50G data rate on a PON with a single channel has proven difficult.

### SUMMARY

In an embodiment, the disclosure includes an Optical Line Terminal (OLT) comprising a downstream transceiver coupled to a Passive Optical Network (PON). The downstream transceiver is configured to communicate over a plurality of bonded channels. An upstream transceiver is configured to receive a downstream Service Data Unit (SDU), the downstream SDU including user data. A processor is coupled to the upstream transceiver and to the downstream transceiver. The processor is configured to split the downstream SDU into a plurality of downstream blocks. The processor distributes the downstream blocks amongst selected bonded channels, with the distributing being based on bonded channel availability for transmission over the PON via the downstream transceiver. Splitting a SDU and distributing the resulting blocks over bonded channels allows portions of the SDU to be simultaneously communicated over multiple channels. This results in substantially increased peak transmission speeds for the SDU in comparison to serial communication of the SDU over a single channel.

Optionally, in any of the preceding aspects, another implementation of the aspect includes distributing the plurality of downstream blocks amongst the selected bonded channels based on bonded channel availability, including evenly distributing the plurality of downstream blocks over each available bonded channel at each transmitter buffer index. Even distribution over available channels maximizes the portion of the SDU that can be transmitted at each point in time.

Optionally, in any of the preceding aspects, in another implementation of the aspect, the processor is further configured to employ ten-Gigabit PON Encapsulation Mode (XGEM) frames to encapsulate groups of downstream blocks in the selected bonded channels prior to transmission over the PON. The XGEM frames encapsulate groups of blocks and ensure the blocks are properly transmitted to the receiver as a group.

Optionally, in any of the preceding aspects, in another implementation of the aspect, the processor is further configured to insert Frame Alignment Markers (FAMs) in headers of the XGEM frames to support ordering the plurality of downstream blocks at an Optical Network Unit (ONU) upon receipt of the plurality of downstream blocks over the selected bonded channels. Channels operate at different wavelengths and hence propagate at different speeds, causing skew. FAMs allow blocks to be positioned in the correct order to reconstruct the SDU frame regardless of skew.

Optionally, in any of the preceding aspects, in another implementation of the aspect, the downstream transceiver includes a transmitter with a transmitter buffer, and wherein the FAMs are transmitter buffer indices employed by the transmitter buffer for the corresponding XGEM frames. Transmitter buffer indices can be used as FAMs with minimal processing overhead, which results in faster overall transmission speed.

Optionally, in any of the preceding aspects, in another implementation of the aspect, the plurality of downstream blocks that are split from the downstream SDU include eight bytes of user data.

Optionally, in any of the preceding aspects, in another implementation of the aspect, the downstream transceiver is configured to receive a first Physical Layer Operations, Administration, and Maintenance (PLOAM) message from the ONU, the first PLOAM message indicating available channels for simultaneous upstream communication by the ONU and available channels for simultaneous downstream communication by the ONU. PLOAM messages can be used to determine available channels for bonding as well as bonding assignments. This allows the OLT to setup bonded channels.

Optionally, in any of the preceding aspects, in another implementation of the aspect, the downstream transceiver is configured to transmit a second PLOAM message to the ONU, the second PLOAM message assigning the selected bonded channels based on the bonded channel availability, the selected bonded channels being assigned for communication of the plurality of downstream blocks from the downstream SDU.

Optionally, in any of the preceding aspects, in another implementation of the aspect, the first PLOAM message is a Serial Number ONU message, a Channel Report message, or a Tuning Response message, and wherein the second PLOAM message is an Assign ONU Identifier (ID) message or a Channel Bonding Response message.

Optionally, in any of the preceding aspects, another implementation of the aspect includes a memory, wherein the processor is further configured to generate a Gigabit PON Encapsulation (GEM) Bonding Service Profile (GBSP) managed entity instance for the ONU. The GBSP managed entity is configured to synchronize a managed entity file with an ONU Three Gigabit (ONU3-G) managed entity operating at the ONU and store the managed entity file in the memory. The managed entity file includes available channels for simultaneous upstream communication by the ONU. The managed entity file also includes available channels for simultaneous downstream communication by the ONU. The managed entity file also includes bonded channels for upstream communication and downstream communication between the OLT and ONU. Synchronizing the managed entity files allows the OLT to determine available channels for bonding as well as communicate bonding assignments. This allows the OLT to setup bonded channels.

Optionally, in any of the preceding aspects, in another implementation of the aspect, the downstream transceiver is further configured to receive a plurality of upstream blocks distributed amongst second selected bonded channels based on bonded channel availability. The processor is further configured to reassemble the plurality of upstream blocks received from the second selected bonded channels over the PON into an upstream SDU, the upstream SDU including user data, and forward the upstream SDU via the upstream transceiver. Both the OLT and ONU can employ channel bonding in both the upstream and downstream directions. This allows for increased peak communication speeds for both uploads and downloads.

In an embodiment, the disclosure includes a method implemented in an OLT. The method comprises receiving a downstream SDU including user data at an upstream transceiver. The downstream SDU is split into a plurality of downstream blocks. The downstream blocks are distributed amongst selected bonded channels, with the distributing being based on bonded channel availability. The downstream blocks are transmitted over a PON via the selected bonded channels. Splitting a SDU and distributing the resulting blocks over bonded channels allows portions of the SDU to be simultaneously communicated over multiple channels. This results in substantially increased peak transmission speeds for the SDU in comparison to serial communication of the SDU over a single channel.

Optionally, in any of the preceding aspects, in another implementation of the aspect, the distributing the downstream blocks amongst selected bonded channels based on bonded channel availability includes evenly distributing the plurality of downstream blocks over each selected bonded channel at each transmitter buffer index. Even distribution over available channels maximizes the portion of the SDU that can be transmitted at each point in time.

Optionally, in any of the preceding aspects, another implementation of the aspect includes encapsulating, by the processor, groups of downstream blocks in the bonded channels with XGEM frames prior to transmitting the plurality of downstream blocks over the PON. The XGEM frames encapsulate groups of blocks and ensure the groups of blocks are properly transmitted to the receiver as a group.

Optionally, in any of the preceding aspects, another implementation of the aspect includes inserting, by the processor, FAMs in headers of the XGEM frames to support ordering the plurality of downstream blocks at an ONU upon receipt of the plurality of downstream blocks over the selected bonded channels. Channels operate at different wavelengths and hence propagate at different speeds causing skew. FAMs allow blocks to be positioned in the correct order to reconstruct the SDU frame, regardless of skew.

Optionally, in any of the preceding aspects, in another implementation of the aspect, the FAMs are transmitter buffer indices employed by a transmitter buffer for the corresponding XGEM frames. Transmitter buffer indices can be used as FAMs with minimal processing overhead, which results in faster overall transmission speed.

Optionally, in any of the preceding aspects, in another implementation of the aspect, the downstream blocks that are split from the downstream SDU include eight bytes of user data.

Optionally, in any of the preceding aspects, another implementation of the aspect includes receiving, at the downstream transceiver, a first Physical Layer Operations, Administration, and Maintenance (PLOAM) message from the ONU, the first PLOAM message indicating available channels for simultaneous upstream communication by the ONU and available channels for simultaneous downstream communication by the ONU. PLOAM messages can be used to determine available channels for bonding as well as bonding assignments. This allows the OLT to setup bonded channels.

Optionally, in any of the preceding aspects, another implementation of the aspect includes transmitting, by the downstream transceiver, a second PLOAM message to the ONU, the second PLOAM message assigning the selected bonded channels based on the bonded channel availability, the selected bonded channels being assigned for communication of the plurality of downstream blocks from the downstream SDU.

Optionally, in any of the preceding aspects, in another implementation of the aspect, the first PLOAM message is a Serial Number ONU message, a Channel Report message, or a Tuning Response message, and wherein the second PLOAM message is an Assign ONU ID message or a Channel Bonding Response message.

Optionally, in any of the preceding aspects, another implementation of the aspect includes generating a GBSP managed entity to synchronize a managed entity file with an ONU3-G managed entity operating at the ONU. The managed entity file is stored in a memory. The managed entity file includes available channels for simultaneous upstream communication by the ONU. The managed entity file also includes available channels for simultaneous downstream communication by the ONU. The managed entity file includes bonded channels for upstream communication and downstream communication between the OLT and ONU. Synchronizing the managed entity files allows the OLT to determine available channels for bonding as well as communicate bonding assignments. This allows the OLT to setup bonded channels.

Optionally, in any of the preceding aspects, another implementation of the aspect includes receiving, at the downstream transceiver, a plurality of upstream blocks distributed amongst the selected bonded channels based on the bonded channel availability. The plurality of upstream blocks, as received from the selected bonded channels over the PON, are reassembled into an upstream SDU including user data. The upstream SDU is forwarded via the upstream transceiver. Both the OLT and ONU can employ channel bonding in both the upstream and downstream directions. This allows for increased peak communication speeds for both uploads and downloads.

In an embodiment, the disclosure includes an Optical Network Unit (ONU). The ONU comprises a transceiver coupled to a PON. The transceiver is configured to communicate over the PON via a plurality of bonded channels. The transceiver is also configured to receive a plurality of downstream blocks distributed amongst selected bonded channels, with the distributing being based on bonded channel availability. A processor is coupled to the transceiver. The processor is configured to reassemble the plurality of downstream blocks received from the selected bonded channels over the PON into a downstream SDU, the downstream SDU including user data. The processor is also configured to forward the downstream SDU toward a user device via a downstream interface. Splitting a SDU and distributing the resulting blocks over selected bonded channels allows portions of the SDU to be simultaneously communicated over multiple bonded channels. This results in substantially increased peak transmission speeds for the SDU in comparison to serial communication of the SDU over a single channel.

Optionally, in any of the preceding aspects, in another implementation of the aspect, the plurality of downstream blocks are distributed equally amongst the selected bonded channels available at each transmitter buffer index. Even distribution over available bonded channels maximizes the portion of the SDU that can be transmitted at each point in time.

Optionally, in any of the preceding aspects, in another implementation of the aspect, the plurality of downstream blocks are received in XGEM frames, each XGEM frame encapsulating a group of downstream blocks in a common bonded channel. The XGEM frames encapsulate groups of blocks and ensure the blocks are properly transmitted to the receiver as a group.

Optionally, in any of the preceding aspects, in another implementation of the aspect, the processor is further configured to obtain FAMs in headers of the XGEM frames. The plurality of downstream blocks are ordered for reassembly into the downstream SDU based on the FAMs. Channels operate at different wavelengths and hence propagate at different speeds, causing skew. FAMs allow blocks to be positioned in the correct order to reconstruct the SDU frame regardless of skew.

Optionally, in any of the preceding aspects, in another implementation of the aspect, the FAMs are transmitter buffer indices that are employed by an OLT transmitter buffer for the corresponding XGEM frames. Transmitter buffer indices can be used as FAMs with minimal processing overhead, which results in faster overall transmission speed.

Optionally, in any of the preceding aspects, in another implementation of the aspect, the plurality of downstream blocks include eight bytes of user data.

Optionally, in any of the preceding aspects, in another implementation of the aspect, the transceiver is configured to transmit a first Physical Layer Operations, Administration, and Maintenance (PLOAM) message to the OLT, the first PLOAM message indicating the bonded channel availability for simultaneous upstream communication by the ONU and available channels for simultaneous downstream communication by the ONU. PLOAM messages can be used to determine available channels for bonding, as well as bonding assignments. This allows the OLT to setup bonded channels.

Optionally, in any of the preceding aspects, in another implementation of the aspect, the transceiver is configured to receive a second PLOAM message from the OLT, with the second PLOAM message assigning the selected bonded channels based on the bonded channel availability and assigning the selected bonded channels being assigned for communication of the plurality of downstream blocks of the downstream SDU.

Optionally, in any of the preceding aspects, in another implementation of the aspect, the first PLOAM message is a Serial Number ONU message, a Channel Report message, or a Tuning Response message, and wherein the second PLOAM message is an Assign ONU ID message or a Channel Bonding Response message.

Optionally, in any of the preceding aspects, another implementation of the aspect includes a memory. The processor is further configured to generate an ONU3-G managed entity that is configured to synchronize a managed entity file with a GBSP managed entity instance operating on the OLT and store the managed entity file in the memory. The managed entity file includes available channels for simultaneous upstream communication by the ONU. The managed entity file also includes available channels for simultaneous downstream communication by the ONU. The managed entity file also includes bonded channels for upstream communication and downstream communication between the OLT and ONU. Synchronizing the managed entity files allows the OLT to determine available channels for bonding as well as communicate bonding assignments. This allows the OLT to setup bonded channels.

Optionally, in any of the preceding aspects, in another implementation of the aspect, the downstream interface is further configured to receive an upstream SDU, the upstream SDU including user data. The processor is further configured to split the upstream SDU into a plurality of upstream blocks, and distribute the plurality of upstream blocks amongst second selected bonded channels based on bonded channel availability for transmission over the PON via the transceiver. Both the OLT and ONU can employ channel bonding in both the upstream and downstream directions. This allows for increased peak communication speeds for both uploads and downloads.

In an embodiment, the disclosure includes a method implemented in an ONU. The method comprises receiving, at a transceiver coupled to a Passive Optical Network (PON), a plurality of downstream blocks distributed amongst selected bonded channels, with the distributing being based on bonded channel availability. The plurality of downstream blocks, as received from the selected bonded channels over the PON, are reassembled into a downstream SDU, the downstream SDU including user data. The downstream SDU is forwarded toward a user device via a downstream interface. Splitting a SDU and distributing the resulting blocks over the selected bonded channels allows portions of the SDU to be simultaneously communicated over multiple bonded channels. This results in substantially increased peak transmission speeds for the SDU in comparison to serial communication of the SDU over a single channel.

Optionally, in any of the preceding aspects, in another implementation of the aspect, the plurality of downstream blocks are distributed equally amongst the selected bonded channels available at each transmitter buffer index. Even distribution over available bonded channels maximizes the portion of the SDU that can be transmitted at each point in time.

Optionally, in any of the preceding aspects, in another implementation of the aspect, the plurality of downstream blocks are received in XGEM frames, where each XGEM frame encapsulates a group of downstream blocks in a common bonded channel. The XGEM frames encapsulate groups of blocks and ensure the groups of blocks are properly transmitted to the receiver as a group.

Optionally, in any of the preceding aspects, another implementation of the aspect includes obtaining FAMs in headers of the XGEM frames. The plurality of downstream blocks are ordered for reassembly into the downstream SDU based on the FAMs. Channels operate at different wavelengths and hence propagate at different speeds, causing skew. FAMs allow blocks to be positioned in the correct order to reconstruct the SDU frame regardless of skew.

Optionally, in any of the preceding aspects, in another implementation of the aspect, the FAMs are transmitter buffer indices employed by an Optical Line Terminal (OLT) transmitter buffer for the corresponding XGEM frames. Transmitter buffer indices can be used as FAMs with minimal processing overhead, which results in faster overall transmission speed.

Optionally, in any of the preceding aspects, in another implementation of the aspect, the plurality of downstream blocks include eight bytes of user data.

Optionally, in any of the preceding aspects, another implementation of the aspect includes transmitting, by the transceiver, a first Physical Layer Operations, Administration, and Maintenance (PLOAM) message to the OLT, the first PLOAM message indicating available channels for simultaneous upstream communication by the ONU and available channels for simultaneous downstream communication by the ONU. PLOAM messages can be used to determine available channels for bonding as well as bonding assignments. This allows the OLT to setup bonded channels.

Optionally, in any of the preceding aspects, another implementation of the aspect includes receiving, at the transceiver, a second PLOAM message from the OLT, the second PLOAM message assigning the selected bonded channels based on the bonded channel availability, the selected bonded channels being assigned for communication of the plurality of downstream blocks of the downstream SDU.

Optionally, in any of the preceding aspects, in another implementation of the aspect, the first PLOAM message is a Serial Number ONU message, a Channel Report message, or a Tuning Response message, and wherein the second PLOAM message is an Assign ONU ID message or a Channel Bonding Response message.

Optionally, in any of the preceding aspects, another implementation of the aspect includes, generating, by the processor, an ONU3-G managed entity configured to synchronize a managed entity file with a GBSP managed entity instance operating on the OLT, and store the managed entity file in memory. The managed entity file includes available channels for simultaneous upstream communication by the ONU. The managed entity file also includes available channels for simultaneous downstream communication by the ONU. The managed entity file also includes bonded channels for upstream communication and downstream communication between the OLT and ONU. Synchronizing the managed entity files allows the OLT to determine available channels for bonding as well as communicate bonding assignments. This allows the OLT to setup bonded channels.

Optionally, in any of the preceding aspects, another implementation of the aspect includes receiving an upstream SDU including user data at the downstream interface. The upstream SDU is split into a plurality of upstream blocks. At the transceiver, the plurality of upstream blocks are distributed amongst second selected bonded channels based on bonded channel availability for transmission over the PON. The second selected bonded channels can be the same or different from the selected bonded channels. Both the OLT and ONU can employ channel bonding in both the upstream and downstream directions. This allows for increased peak communication speeds for both uploads and downloads.

In an embodiment, the disclosure includes a non-transitory computer readable medium comprising a computer program product for use by an OLT. The computer program product comprises computer executable instructions stored on the non-transitory computer readable medium such that when executed by a processor to cause the OLT to perform any of the preceding aspects.

In an embodiment, the disclosure includes a non-transitory computer readable medium comprising a computer program product for use by an ONU. The computer program product comprises computer executable instructions stored on the non-transitory computer readable medium such that, when executed by a processor, cause the ONU to perform any of the preceding aspects.

In an embodiment, the disclosure includes an OLT. The OLT comprises an upstream communication means for receiving a downstream SDU including user data. The OLT also comprises a splitting means for splitting the downstream SDU into a plurality of downstream blocks. The OLT also comprises a distributing means for distributing the plurality of downstream blocks amongst selected bonded channels, with the distributing being based on bonded channel availability. The OLT also comprises a downstream communication means for transmitting the plurality of downstream blocks over a PON via the selected bonded channels.

Optionally, in any of the preceding aspects, in another implementation of the aspect, the splitting means, distributing means, and downstream communication means are further configured for performing any of the preceding aspects.

In an embodiment, the disclosure includes an ONU comprising an upstream communication means for receiving a plurality of downstream blocks from a PON, and distributing the plurality of downstream blocks amongst selected bonded channels, with the distributing being based on bonded channel availability. The ONU also comprises a reassembling means for reassembling the plurality of downstream blocks received from the selected bonded channels over the PON into a downstream SDU, the downstream SDU including user data. The ONU also comprises a downstream communication means for forwarding the downstream SDU toward a user device via a downstream interface.

Optionally, in any of the preceding aspects, in another implementation of the aspect, the upstream communication means, reassembling means, and forwarding means are further configured for performing any of the preceding aspects.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an example PON.

FIG. 2 is a schematic diagram illustrating an example scheme for subdividing a Service Data Unit (SDU) for communication over a multi-channel PON.

FIGS. 3A-3C are schematic diagrams illustrating an example protocol for communicating a subdivided SDU over bonded PON channels.

FIG. 4 is a schematic diagram of an example ten-Gigabit PON Encapsulation Mode (XGEM) header including a Frame Alignment Marker (FAM).

FIG. 5 is a protocol diagram illustrating an example mechanism for bonding PON channels with Physical Layer Operations, Administration, and Maintenance (PLOAM) messages.

FIG. 6 is a protocol diagram illustrating another example mechanism for bonding PON channels with PLOAM messages.

FIG. 7 is a protocol diagram illustrating an example mechanism for modifying a PON channel bonding with PLOAM messages.

FIG. 8 is a schematic diagram illustrating an example mechanism for bonding PON channels with managed entities.

FIG. 9 is a schematic diagram of an example network element for use in a PON.

FIG. 10 is a flowchart of an example method of transmitting data over bonded channels in a PON.

FIG. 11 is a flowchart of an example method of receiving data over bonded channels in a PON.

FIG. 12 is an embodiment of a device for communicating data over bonded channels in a PON.

FIG. 13 is an embodiment of another device for communicating data over bonded channels in a PON.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

In order to achieve a 50G data rate, PON components may simultaneously communicate over multiple channels. A channel is a predetermined group of wavelengths (or frequencies). Hence, different channels operate at different wavelengths and corresponding frequencies. Signals in different channels can be modulated onto a shared optical carrier to create an optical signal. The optical signal is communicated downstream and/or upstream between an Optical Line Terminal (OLT) at a central office and Optical Network Units (ONUs) at customer premises. The optical signal is received and employed to reconstruct the different sub-signals based on the channel. Such a process may be referred to a wavelength division multiplexing. The OLT can transmit downstream over multiple channels, in which case the ONUs receive data over multiple channels. Further, the ONUs can transmit upstream over multiple channels, in which case the OLT receives data over multiple channels.

In order to accomplish multi-channel communication, the OLT and ONUs may be equipped with multiple channel specific optical transceivers. Each optical transceiver may be treated as a separate physical interface from a hardware standpoint. Multi-channel communication can be employed to simultaneously communicate multiple data signals. Further, multi-channel communication can be employed to simultaneously communicate multiple parts of a single data signal, which can approximately double, triple, quadruple, etc. the data rate of the data signal depending on the number of channels employed. Multi-channel communication of a single signal in a PON can be accomplished by channel bonding. Channel bonding is a mechanism that combines multiple channel specific physical interfaces into a single logical link in the Media Access Control (MAC) layer. When ONUs include multiple optical transceivers, channel bonding enables the ONUs to achieve much higher peak data rates than is possible with a single channel system. In order to use channel bonding to achieve such increased peak data rates, the PON protocol layer should distribute user data in bonding units to the bonded channels at the sending side. Further, the PON protocol layer should be able to reassemble the received bonding units in the correct order at the receiving side.

Disclosed herein are example improvements to the ITU-T International Telecommunication Union Telecommunications Standardization Sector (ITU-T) PON protocol that allow for the creation and use of bonded channels. In the disclosed examples, a SDU, such as a MAC layer Ethernet frame, is obtained for transmission across a PON (e.g., from an OLT to an ONU or vice versa). The SDU is broken down into blocks. Such blocks may be eight bytes long. The blocks are transmitted over bonded channels based on channel availability. For example, the blocks may be split equally amongst all bonded channels that are available at each instance, as indicated by a transmitter buffer index. The blocks can be stored in a transmitter buffer to prepare for transmission. Blocks allocated to a common channel can be encapsulated in an XGEM frame prior to transmission. The XGEM frame may include a FAM, which may be a counter value and/or a transmitter buffer index. The FAM can be used by the receiver to reassemble the blocks into the correct order. For example, different channels operate at different wavelengths, and hence blocks traversing different channels propagate across the ODN at different speeds. Hence, the blocks may be received out of order. The FAM can be employed by the receiver to determine the relative order of block assignment to the XGEM frames, and hence to determine the relative order of the blocks. The disclosure also includes mechanisms for creating the bonded channels to support such communication. In one example embodiment, the ONUs and OLT exchange PLOAM messages. A PLOAM message from the ONU indicates the channels that an ONU can employ for simultaneous upstream transmission and downstream receipt. The OLT then selects and assigns bonded channels to the ONU, and forwards such assignments to the ONU via a responsive PLOAM message. Other PLOAM messages can be employed to adjust channel bonding assignments when an ONU is directed to adjust channel usage. In another example embodiment, the ONU generates an ONU Three Gigabit (ONU3-G) managed entity, and the OLT generates a corresponding Gigabit PON Encapsulation (GEM) Bonding Service Profile (GBSP) managed entity instance. Each entity maintains a local copy of a managed entity file in memory. The managed entity file is synchronized periodically and/or upon the occurrence of a predetermined event. The managed entity file includes the channels that an ONU can employ for simultaneous upstream transmission and downstream receipt as specified by the corresponding ONU. The managed entity file also includes the bonded channel assignments as specified by the OLT.

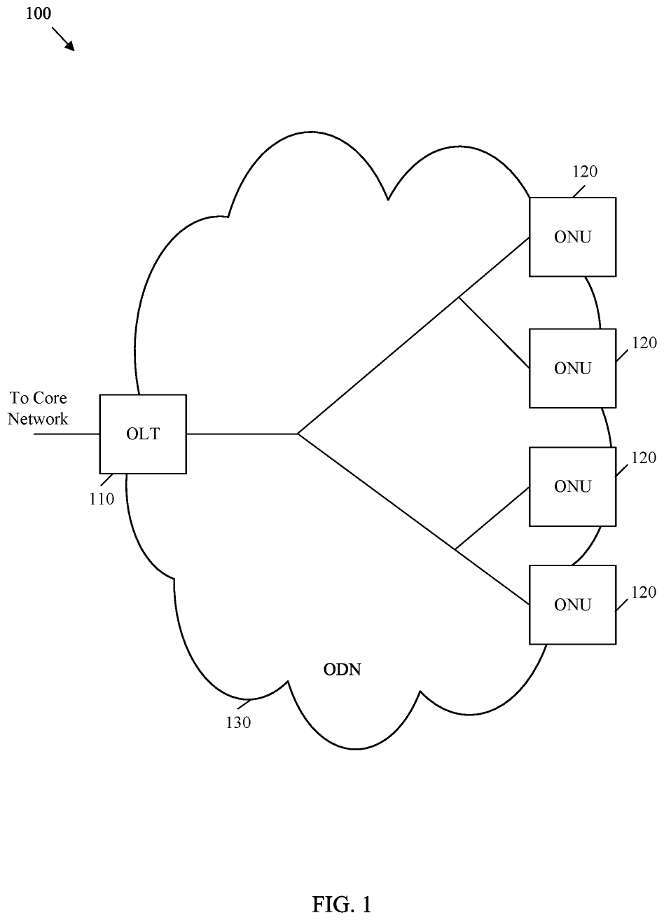

FIG. 1 is a schematic diagram of an embodiment of a PON 100. The PON 100 comprises an OLT 110, a plurality of ONUs 120, and an ODN 130, which couples the OLT 110 and the ONUs 120. The PON 100 is a communications network that does not require any active components to distribute data between the OLT 110 and the ONUs 120. Instead, the PON 100 uses passive optical components in the ODN 130 to distribute data between the OLT 110 and the ONUs 120. The PON 100 may be configured to operate according to an ITU-T based protocol. For example, the PON 100 may employ messages as described in ITU-T Recommendation G.9807.1 and/or G.989.3. The PON 100 serves as an access network, and is designed to serve as the last mile connection between end users and the Internet. Further, the PON 100 is configured so that signals from the OLT 110 are communicated to all ONUs 120. Specifically, the OLT 110 allocates downstream time slots and/or channels for each ONU 120, and the ONUs 120 read data received at their respective time slots. Further, the OLT 110 assigns upstream time slots and/or channels so that each ONU 120 can send upstream data in a manner that does not interfere with data from other ONUs 120.

An OLT 110 is an optical device configured to communicate data from a core network (e.g., the Internet) downstream towards the ONUs 120, and communicate upstream data from the ONUs 120 toward the core network. Specifically, the OLT 110 acts as an intermediary between the core network and the ONUs 120. The OLT 110 may be located at a central location, such as a central office, but may be located at other locations as well. The OLT 110 generally contains one or more transmitters, receivers, and/or transceivers, referred to collectively as transceivers for clarity, configured as upstream interfaces for communicating with the core network. The OLT 110 also generally contains one or more downstream transceivers configured as downstream interfaces for communicating with the ONUs 120. In multi-channel implementations, different interfaces communicate over different channels. For example, a first interface may communicate over a first channel, a second interface may communicate over a second channel, etc. As used herein, a channel is a bounded group of wavelengths (or frequencies). Hence, different channels operate at different wavelengths and corresponding frequencies. The OLT 110 may employ such interfaces to modulate multiple wavelength signals onto a single optical carrier, which generates an optical signal containing multiple data signals at different wavelengths/frequencies.

The ODN 130 is a data distribution system. The ODN 130 may include optical fiber cables, couplers, splitters, distributors, and/or other equipment for communicating optical signals between the OLT 110 and the ONUs 120. Such optical fiber cables, couplers, splitters, distributors, and/or other equipment are passive optical components. Specifically, the optical fiber cables, couplers, splitters, distributors, and/or other equipment are components that do not require any power to distribute data signals between the OLT 110 and the ONUs 120. Accordingly, the ODN 130 propagates optical signals between the OLT 110 and the ONUs 120 without making changes to such signals (e.g., without switching packets). In some cases, the ODN 130 may comprise some active components, such as optical amplifiers, for maintaining signal quality and/or mitigating signal loss. The ODN 130 may extend from the OLT 110 to the ONUs 120 in a branching configuration as shown in FIG. 1, but may also be configured in any other point-to-multi-point configurations.

An ONU 120 is device that is configured to communicate data between the OLT 110 and a customer or user. Specifically, an ONU 120 may act as an intermediary between the OLT 110 and the customer. For instance, the ONUs 120 may receive data from the OLT 110 on an upstream interface and forward such data to a customer on a downstream interface, and vice versa. For example, the ONUs 120 may comprise one or more upstream interfaces that each include an optical transceiver (e.g., an optical transmitter and an optical receiver) configured to couple to the ODN 130. The ONU 120 also includes one or more downstream interfaces, such as Ethernet ports, for communicating with a local network, such as a home or office network. Additionally, the ONUs 120 may comprise a converter that converts the received optical signal from the OLT 110 into an electrical signal for the customer, such as signals in the Ethernet or asynchronous transfer mode (ATM) protocol. In examples that employ multiple channels, the ONUs 120 may include multiple upstream interfaces for transmitting and receiving optical signal data in corresponding channels.

As noted above, OLTs 110 and ONUs 120 can increase peak data rates by employing channel bonding to logically combine multiple channel specific interfaces into a single logical link for purposes of Open Systems Interconnect (OSI) model layer two type communications. For example, the OLT 110 can bond multiple downstream interfaces into a logical link. The OLT 110 can then break a SDU, such as an Ethernet frame, from the core network into multiple blocks and simultaneously send the blocks over multiple downstream interfaces, and hence over multiple channels. In this manner, the SDU blocks are transmitted across the ODN 130 in parallel instead of in series. The ONU 120 can receive the blocks on multiple upstream interfaces and can order the received blocks to reconstruct the SDU. The same process can also occur for upstream communication. For example, a SDU from a local network (e.g., from a user) can be split into multiple blocks and forwarded across multiple upstream interfaces at the ONU 120. The OLT 110 can receive the blocks on multiple downstream interfaces and can reconstruct the SDU for communication towards the core network. The following FIGS. describe various example mechanisms for dividing, transmitting, and reconstructing an SDU by employing bonded channels as well as provide example mechanisms to bond channels for such communications.

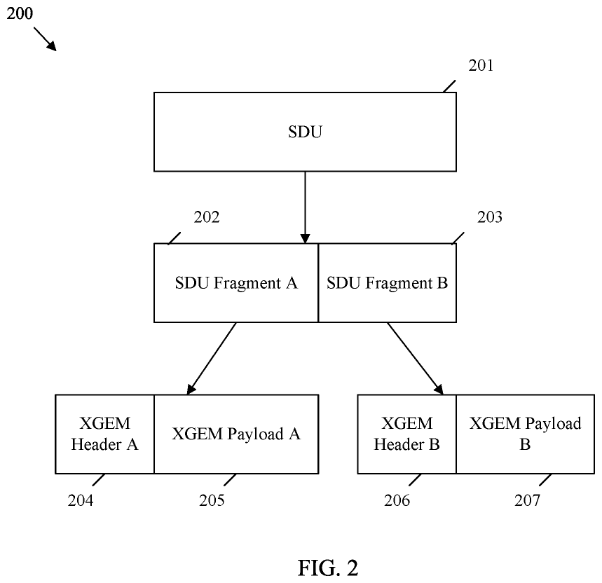

FIG. 2 is a schematic diagram illustrating an example scheme 200 for subdividing a SDU 201 for communication over a multi-channel PON, such as PON 100. An SDU 201 is packet/frame, such as an Ethernet frame, that includes an upper OSI layer user and/or application data. An SDU 201 can be subdivided by scheme 200 and forwarded over a bonded group of channels. For example, an SDU 201 can be received at an OLT, such as OLT 110, subdivided for downstream communication over a bonded channel, and reconstructed at an ONU, such as ONU 120. In another example, the SDU 201 can be received at an ONU from a local network, subdivided for upstream communication over a bonded channel, and reconstructed at an OLT for communication towards a core network.

The SDU 201 may include a header, a payload, metadata, etc. The transmitter splits the SDU 201 into a plurality of fragments of predetermined size. In the example shown in FIG. 2, the SDU 210 is subdivided into a SDU fragment A 202 and an SDU fragment B 203. The SDU fragments 202 and 203 may be the same size or may be different sizes. In some examples, SDU fragments 202 and 203 each contain eight bytes of data (or less for the last fragment). While two SDU fragments 202 and 203 are shown for ease of discussion, the SDU 201 can be split into any number of fragments. The SDU fragments 202 and 203 may also be referred to a blocks herein. The SDU fragments 202 and 203 act as channel bonding units that can be transmitted over bonded transmitting interfaces in a pre-decided order.

The transmitter can encapsulate the SDU fragments 202 and 203 into XGEM frames according to XGEM encapsulation (e.g., according to an ITU-T PON protocol). An XGEM frame is a container employed to carry user data over PONs. An XGEM frame includes an XGEM header containing control information and an XGEM payload containing user data. Hence, the SDU fragment A 202 is converted into an XGEM payload A 205 when the SDU fragment A 202 is encapsulated by an XGEM header A 204. Further, the SDU fragment B 203 is converted into an XGEM payload B 207 when the SDU fragment B 203 is encapsulated by an XGEM header B 206. The XGEM frames can then be transmitted over separate bonded channels. In some cases, multiple SDU fragments 202 and/or 203 can be allocated to a common channel and encapsulated by a single XGEM header 204 and/or 206. In such a case, a separate XGEM frame can be employed for each channel. Hence, the XGEM frames, including XGEM headers 204 and 206 and XGEM payloads 205 and 207, can be employed to encapsulate groups of blocks in assigned bonded channels prior to transmission over a PON.

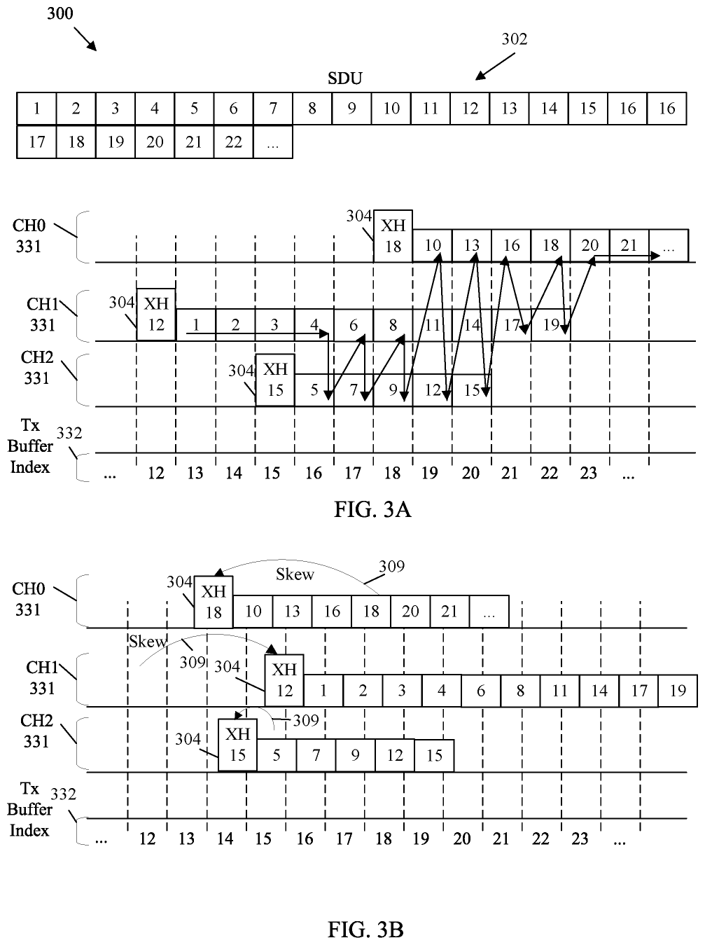

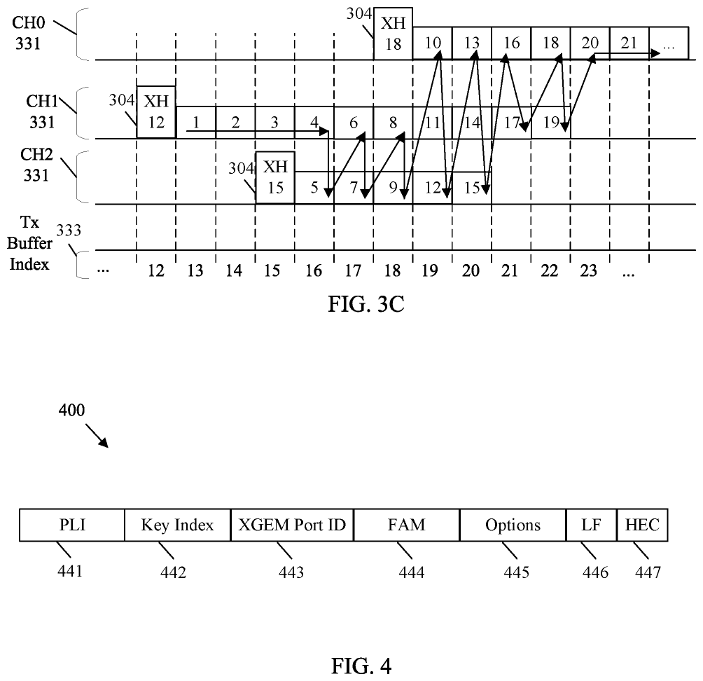

FIGS. 3A-3C are schematic diagrams illustrating an example protocol 300 for communicating a subdivided SDU, such as SDU 201, over bonded PON channels, such as in a PON 100. Alternatively, the protocol could be referenced as a protocol portion, a data structure, or a communication scheme.

Referring first to FIG. 3A, an SDU containing user data is obtained and prepared for transport over a group of bonded channels 331, in this case channel 0 (CH0), channel 1 (CH1), and channel 2 (CH2). Such bonded channels 331 are assigned by the OLT based on the channels available for upstream and/or downstream bonding at the ONU (e.g., as described in more detail with respect to the FIGS. below). Protocol 300 is agnostic as to direction. So an OLT can employ protocol 300 to transmit downstream to an ONU, or an ONU can employ protocol 300 to transmit upstream to an OLT, depending on the example. The SDU is first split/divided into a plurality of blocks 302, for example as described in scheme 200. For purposes of illustration, the SDU is divided into twenty-two blocks 302. However, the SDU can be divided into any number of blocks 302 as desired to communicate the entire SDU. In this example, each block 302 that is split from the SDU is eight bytes long, and hence includes eight bytes of user data, packet header data, metadata, etc.

The blocks 302 are then distributed amongst the bonded channels 331 based on bonded channel 331 availability, for transmission over the PON. In this example, a transmitter buffer is employed to distribute the blocks 302. The transmitter buffer includes memory capable of storing and/or queueing blocks 302 for transit over corresponding channels 331. The transmitter buffer stores the blocks 302 according to a bonded channel 331 and a transmitter buffer index 332. For purposes of illustration, the blocks 302 are assigned to channels 331 at transmitter buffer indices 332 of twelve to twenty three in the present example. In the present example, a transmitter buffer index 332 (that corresponds with a channel 331 that does not contain a block 302) indicates that the channel 331 is unavailable at that transmitter buffer index 332. A channel 331 can be unavailable because the channel 331 is already in use for transmission of an unrelated communication.

In order to prepare the blocks 302 for transmission, an XGEM header 304 is attached to the blocks 302 allocated to a common channel. The XGEM headers 304 may be substantially similar to XGEM header 204 and/or 206. The XGEM headers 304 each include a Frame Allocation Marker (FAM), which can be used to reassemble the blocks 302 in the correct order at the receiver. While the FAM may be any counter value, in this case the FAM is selected as the transmitter buffer index 332 that is employed by the transmitter buffer as the starting point of the corresponding XGEM frame (e.g., as a position index). For example, the first available buffer index 332 for CH0 is eighteen, the first available buffer index 332 for CH1 is twelve, and the first available buffer index 332 for CH2 is fifteen, respectively. Hence, the XGEM headers 304 for CH0, CH1, and CH2 are positioned at buffer indices 332 eighteen, twelve, and fifteen, respectively. Further, the XGEM headers 304 for CH0, CH1, and CH2 receive FAMs eighteen, twelve, and fifteen, respectively.

Once the XGEM headers 304 are stored in the transmit buffer, the SDN blocks 302 are distributed amongst the bonded channels 331 based on channel 331 availability from lowest channel to highest channel. Specifically, the SDN blocks 302 are evenly distributed over each available bonded channel 331 at each transmitter buffer index 332. In the example shown, CH0 is available from transmitter buffer index 332 eighteen to twenty four, CH1 is available from transmitter buffer index 332 twelve to twenty two, and CH2 is available from transmitter buffer index 332 fifteen to twenty. The blocks 302 are positioned in the transmit buffer in order following the corresponding XGEM headers 304. Accordingly, CH1 is the only channel 331 available to receive blocks 302 from buffer index 332 thirteen to fifteen, and therefore blocks 302 one, two, and three are positioned in order at the corresponding buffer indices 332 at CH1. From buffer index 332 sixteen to index 332 eighteen, both CH1 and CH2 are available. As such, blocks 302 four through nine are distributed evenly between CH1 and CH2 in order from lowest channel to highest channel. From buffer index 332 nineteen to buffer index 332 twenty, CH0, CH1 and CH2 are all available. Hence, blocks 302 ten through fifteen are distributed evenly between CH0, CH1, and CH2 in order from lowest channel to highest channel. From buffer index 332 twenty one to buffer index 332 twenty two, CH0 and CH1 are all available. As such, blocks 302 sixteen through nineteen are distributed evenly between CH0 and CH1 in order from lowest channel to highest channel. From buffer index 332 twenty three to buffer index 332 twenty four only CH0 is available. Thus, blocks 302 twenty through twenty one are positioned in order in CH0. Once the blocks 302 are positioned in the transmitter buffer, the XGEM header 304 for a channel 331 and blocks 302 assigned to the channel 331 form an XGEM frame.

Referring now to FIG. 3B, the XGEM frames for each channel 331 are transmitted across the PON. The XGEM frames on different channels 331 can be transmitted simultaneously to the extent that channel 331 availability allows, which significantly increases the effective bit rate in comparison to a single channel 331 system. However, the physical characteristics of the channels 331 may cause the XGEM frames to propagate across the PON at different speeds. Specifically, each channel 331 operates at a different wavelength and frequency. Hence, the XGEM frames at each channel 331 are modulated to different wavelengths, with longer wavelengths employing more time to encode an XGEM frame than shorter wavelengths. Such differences, as well as other channel 331 specific issues, may cause skew 309. Skew 309 is an uneven distribution of otherwise evenly distributed data that occurs while the data is in transit, in this case across a PON. As shown, skew 309 can shift an XGEM frame forward and/or backward relative to other XGEM frames in other channels 331. In the case illustrated, the skew 309 shifts the XGEM frame in CH0 backwards by about four and a half index positions, shifts the XGEM frame in CH1 forward by about three and a half index positions, and shifts the XGEM frame in CH2 backwards by about one and a half index positions. As such, the receiver cannot rely exclusively on the order and the position of the XGEM frames upon receipt to accurately reconstruct the SDU.

Referring now to FIG. 3C, the receiver receives the XGEM frames from the bonded channels 331. The receiver then obtains the FAMs in headers 304 of the XGEM frames. The receiver can then align the XGEM frames to corresponding receiver buffer indices 333 based on the FAM values. This action orders the blocks 302 for reassembly into the SDU based on the FAMs. As shown in FIG. 3C, ordering the XGEM frames based on FAM value results in a receiver buffer index 333 that mirrors the transmitter buffer index 332 shown in FIG. 3A. Hence, ordering the XGEM frames based on FAMs eliminates the channel 331 specific skew 309 impact, and allows blocks 302 to be successfully reassembled. As can be seen by comparing FIGS. 3A-3C, although arrival time of the XGEM frames is not aligned, the FAM values in the XGEM headers 304 cause the receiver to store the XGEM frames to the receiver buffer in the exact position employed at the transmitter buffer. Hence, reassembling error from channel 331 misalignment is avoided.

As a specific example, by employing protocol 300 downstream, an OLT can receive an SDU including user data on an upstream receiver. The OLT can split the SDU into a plurality of blocks 302 and distribute the blocks 302 amongst the bonded channels 331 based on bonded channel 331 availability. Such blocks 302 can then be scheduled for transmission over the PON via a downstream transceiver, so long as the downstream transceiver is coupled to the PON and configured to communicate over the bonded channels. Further, an ONU employing a transceiver coupled to the PON and communicating over the PON via the bonded channels 331 can receive the blocks 302 distributed amongst the bonded channels 331 based on channel 331 availability. The ONU can then reassemble the blocks 302 received from the bonded channels 331 over the PON into the SDU including the user data. The ONU can then forward the SDU toward a user via a downstream interface.

As another specific example, by employing protocol 300 upstream, an ONU can receive an SDU including user data on a downstream interface. The ONU can split the SDU into a plurality of blocks 302 and distribute the blocks 302 amongst the bonded channels 331 based on bonded channel 311 availability. Such blocks 302 can then be scheduled for transmission over the PON via an upstream transceiver, so long as the upstream transceiver is coupled to the PON and configured to communicate over the bonded channels. Further, an OLT employing a transceiver coupled to the PON and communicating over the PON via the bonded channels can receive the blocks 302 distributed amongst the bonded channels 331 based on channel 331 availability. The OLT can then reassemble the blocks 302 received from the bonded channels 331 over the PON into the SDU including the user data. The OLT can then forward the SDU upstream (e.g., toward the Internet) via an upstream transceiver.

FIG. 4 is a schematic diagram of an example XGEM header 400 including a FAM. For example, the XGEM header 400 can be employed to implement XGEM headers 204 and/or 304 to support communication over a multichannel PON, such as PON 100. The XGEM header 400 includes a Payload Length Indication (PLI) field 441, which indicates the length, in bytes, of the XGEM payload (e.g., SDU blocks) following the XGEM header 400. The XGEM header 400 also includes a key index field 442, which indicates any data encryption key used to encrypt the XGEM payload. The XGEM header 400 also includes a XGEM port Identifier (ID) 443, which indicates the XGEM port to which the XGEM frame belongs. The XGEM header 400 also includes a Last Fragment (LF) field 446 that can be set (e.g., to one) to indicate that the XGEM frame contains the last fragment of an SDU or contains a complete SDU. Otherwise the LF field 446 can be set (e.g., to zero) to indicate that the data contained in the XGEM frame is not the last fragment of a larger SDU. The XGEM header 400 also includes a Hybrid Error Correction (HEC) field 447, which contains error detection and correction data for the XGEM header 400 (e.g., an error correction code and a parity bit).

The XGEM header 400 also carries a FAM field 444. The FAM field 444 contains a FAM inserted into the header 400 of the XGEM frame by the OLT or ONU, depending on the example. The FAM field 444 is employed to support ordering the blocks in the XGEM frame for reassembly at the receiver (e.g., the ONU or OLT) upon receipt over the selected bonded channels. The FAM field 444 contains a copy of a counter value generated when the XGEM frame is formed at the sender. This counter may be an intra-frame counter (IFC) associated with the given XGEM frame. The IFC can be used as a transmitter buffer index in some examples. The counter in the FAM field 444 can also be any counter based on the transmitting clock. The FAM field 444 can inherit either the entire counter value or a portion of the counter value. When a portion of the counter value is used for FAM field 444, the higher bits of the counter can be omitted and the lower bits of the counter can be encoded into the FAM field 444.

The XGEM header 400 also includes an options field 445. The options field 445 is generally eighteen bits long and is reserved for data employed for ten-Gigabit PON (XG-PON), ten-Gigabit Symmetric PON (XGS-PON), and Next Generation PON version Two (NG-PON2). When x bits are used for FAM field 444, the options field 445 becomes (18-x) bits. The FAM field 444 size is determined by multiple factors, such as the number of bonded channels, the maximum channel skew, and the implementation of PON chips. In one example, the FAM field 444 is set as sixteen bits, which aligns fields in the XGEM header 400 to bytes.

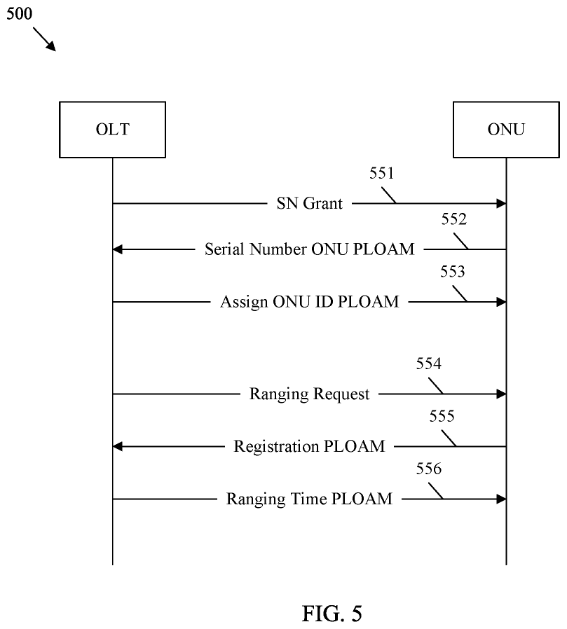

FIG. 5 is a protocol diagram illustrating an example mechanism 500 for bonding PON channels with PLOAM messages. For example, mechanism 500 can be employed to bond channels 331 in a PON 100 in order to support SDU 201 communication via division and transport in XGEM frames including XGEM headers 400. It should be noted that the channel bonding capability of each ONU can be very different. In order to bond channels, the OLT should know the exact channels that can be employed by an ONU. This should be known before bonding some or all of these channels and before communicating data with the ONU. In order to support channel bonding, the ONU should report the ONU's bonding capability to the OLT during activation and/or during operation. Then, the OLT should assign bonded channels to the ONU. Mechanism 500 manages channel bonding by including channel availability and channel bonding assignments in messages employed for other operational purposes in the PON.

Mechanism 500 begins when the OLT sends a Serial Number (SN) grant 551 to the ONU. The OLT periodically sends SN grant 551 messages downstream. The SN grant 551 is an invitation for any unregistered ONU to request an address and/or other ID from the OLT. The ONU responds to the SN grant 551 with a Serial Number ONU PLOAM message 552. The Serial Number ONU PLOAM message 552 is a request to obtain an ONU specific ID from the OLT. The ID can then be employed for further communication. The Serial Number ONU PLOAM message 552 may contain various information related to the communications capabilities of the ONU (e.g., as discussed in more detail with respect to the tables below). The OLT then authenticates the ONU. Presuming the ONU is authorized to connect to the PON, the OLT sends an Assign ONU ID PLOAM message 553. The Assign ONU ID PLOAM message 553 includes the ID used when communicating with the ONU via the PON. The ID can then be stored at the ONU.

In order to avoid collision of upstream messages from multiple ONUs, the OLT performs a ranging procedure. The ranging procedure allows the OLT to determine a transmission delay to add to upstream messages. The transmission delay is specific to each ONU and is primarily based on OLT to ONU distance. The transmission delay adjusts upstream message transmission start time so the upstream messages reach the OLT in the correct timeslot, and hence avoid collision with other messages. The OLT transmits a ranging request message 554 to initiate the ranging procedure. The ONU responds to the ranging request message 554 with a registration PLOAM 555. The registration PLOAM 555 acts as a request to register the ONU with the OLT and receive time slots for upstream and downstream communication. The OLT employs the delay between sending the ranging request 554 and receiving the registration PLOAM 555 to determine transmission delays for the ONU. The OLT then replies with a ranging time PLOAM 556. The ranging time PLOAM 556 contains the delay(s) that should be added to communications as determined by the ranging procedure. Such delays ensure that upstream messages reach the OLT at the correct upstream time slot and that the ONU reads downstream data at the correct time based on an assigned downstream timeslot. The OLT can the assign upstream and downstream timeslots so that data communications between the OLT and ONU can commence.

Channel bonding can be determined and assigned by employing a pair of the PLOAM messages (552, 553) and/or (555, 556). Specifically, a first PLOAM message (e.g., serial number ONU PLOAM 552 or registration PLOAM 555) can be transmitted from an upstream transceiver on the ONU and received by a downstream transceiver at the OLT. The first PLOAM message can be employed to indicate available channels for simultaneous upstream communication by the ONU and available channels for simultaneous downstream communication by the ONU. The OLT can then determine channels for channel bonding based on the available channels indicated by the ONU. A second PLOAM message can then be transmitted from the downstream transceiver on the OLT to the upstream transceiver on the OLT. The second PLOAM message can be employed to assign a plurality of bonded channels based on the available channels. The plurality of bonded channels can then be used for communication of a plurality of blocks from an SDU as discussed above.

As an example, the serial number ONU PLOAM message 552 or the registration PLOAM 555 can be employed as the first message and can include a field for the purpose of indicating available channels for simultaneous upstream and downstream communication between the ONU and OLT. Such channels can be indicated via an upstream bitmap and a downstream bitmap. An example of a serial number ONU PLOAM message 552, as modified to contain a wavelength channel bitmap field to indicate available channels for bonding, is shown in Table 1 below. In this example a maximum of four channels is assumed in each direction. For a system with more than four channels in either direction, a longer bitmap should be employed.

TABLE 1
Serial Number ONU PLOAM message

| Octet | Content | Description |
|---|---|---|
| 1-2 | ONU-ID | 0x03FF, Unassigned ONU-ID |
| 3 | Message type ID | 0x01, “Serial_Number_ONU” |
| 4 | SeqNo | Set to 0x00 for all instances of Serial_Number_ONU PLOAM |
| | | message. |
| 5-8 | Vendor_ID | ONU Vendor-ID code, a four-character combination |
| | | discovered at ONU serial number (SN) acquisition. |
| 9-12 | VSSN | Vendor-specific serial number, a four-byte unsigned integer |
| | | discovered at SN acquisition. |
| 13-16 | Random_delay | The random delay used by the ONU when sending this |
| | | message, expressed in integer bit periods with respect to the |
| | | nominal upstream line rate of 2.48832 Gbit/s, regardless of the |
| | | actual upstream line rate of the ONU. |
| 17-18 | Correlation tag | Octets are not used for XGS-PON, set as 0x00 by the |
| | | transmitter. |
| 19-22 | Current downstream | Octets are not used for XGS-PON, set as 0x00 by the |
| | PON-ID | transmitter. |
| 23-26 | Current upstream | Octets are not used for XGS-PON, set as 0x00 by the |
| | PON-ID | transmitter. |
| 27-34 | Calibration record | Octets are not used for XGS-PON, set as 0x00 by the |
| | status | transmitter. |
| 35 | Timing granularity | Octet is not used for XGS-PON, set as 0x00 by the transmitter. |
| 36 | Step tuning time | Octet is not used for XGS-PON, set as 0x00 by the transmitter. |
| 37 | Upstream line rate | A bitmap of the form 0000 00HL indicating the ONU's |
| | capability | upstream nominal line rate capability: |
| | | H - Upstream nominal line rate of 9.95328 Gbit/s |
| | | H = 0: not supported |
| | | H = 1: supported |
| | | L - Upstream nominal line rate of 2.48832 Gbit/s |
| | | L = 0: supported |
| | | L = 1: not supported |
| 38 | Attenuation | Octet is not used for XGS-PON, set as 0x00 by the transmitter. |
| 39 | Power levelling | Octet is not used for XGS-PON, set as 0x00 by the transmitter. |
| | capability | |
| 40 | Wavelength channel | A bitmap of the form DDDD UUUU indicating the ONU's |
| | bitmap | availability of simultaneously operating in the wavelength |
| | | channels |
| | | DDDD - A bitmap indexed by DWLCH ID; the most |
| | | significant bit (MSB) of nibble correspond to DWLCH ID = |
| | | 11; the least significant bit (LSB) of nibble correspond to |
| | | DWLCH ID = 00. The bit value of 1 indicates that ONU |
| | | supports the corresponding downstream wavelength channel. |
| | | UUUU - A bitmap indexed by UWLCH ID; the MSB of nibble |
| | | correspond to UWLCH ID = 11; the LSB of nibble correspond |
| | | to UWLCH ID = 00. The bit value of 1 indicates ONU |
| | | supports the corresponding upstream wavelength channel. |
| 41-48 | Message integrity | A Message integrity check computed using the default |
| | check (MIC) | PLOAM integrity key. |

As another example, the assigned ONU ID PLOAM message 553 or the ranging time PLOAM 556 can be employed as the second message and can include fields for the purpose of assigning bonded channels between the ONU and OLT based on the available channels indicated by the ONU. Such channels can be indicated via an upstream bitmap and a downstream bitmap. An example of assign ONU ID PLOAM message 553, as modified to contain a downstream wavelength channel bonding set field and an upstream wavelength channel bonding set field to indicate assigned downstream and upstream bonded channels, respectively, is shown in Table 2 below. Specifically, two bytes (e.g., octets fifteen and sixteen) are defined for downstream channel bonding, and another two bytes (e.g., octets seventeen and eighteen) are defined for upstream channel bonding.

TABLE 2
Assign ONU ID message

| Octet | Content | Description |
|---|---|---|
| 1-2 | ONU-ID | 0x03FF, Broadcast ONU-ID. |
| 3 | Message type ID | 0x03, “Assign_ONU-ID”. |
| 4 | SeqNo | Eight-bit broadcast PLOAM sequence number. |
| 5-6 | ONU-ID | LSB-justified 10-bit assigned ONU-ID value padded with six MSB |
| | | zeros; range 0 . . . 1020 (0x0000 . . . 0x03FC). |
| 7-10 | Vendor_ID | ONU Vendor-ID code, a four-character combination discovered at |
| | | ONU SN acquisition. |
| 11-14 | VSSN | Vendor-specific serial number, a four-byte unsigned integer |
| | | discovered at SN acquisition. |
| 15-16 | Downstream | A bitmap indexed by DWLCH ID; the MSB of octet 15 correspond |
| | wavelength | to DWLCH ID = 1111; the LSB of octet 16 corresponds to |
| | channel bonding | DWLCH ID = 0000. The bit value of 1 indicates that the relative |
| | set | downstream wavelength channel attends the channel bonding. |
| 17-18 | Upstream | A bitmap indexed by UWLCH ID; the MSB of octet 17 correspond |
| | wavelength | to UWLCH ID = 1111; the LSB of octet 18 corresponds to |
| | channel bonding | UWLCH ID = 0000. The bit value of 1 indicates that the relative |
| | set | upstream wavelength channel attends the channel bonding. |
| 19-40 | Padding | Set to 0x00 by the transmitter; treated as “don't care” by the |
| | | receiver. |
| 41-48 | MIC | Message integrity check, computed using the default PLOAM |
| | | integrity key. |

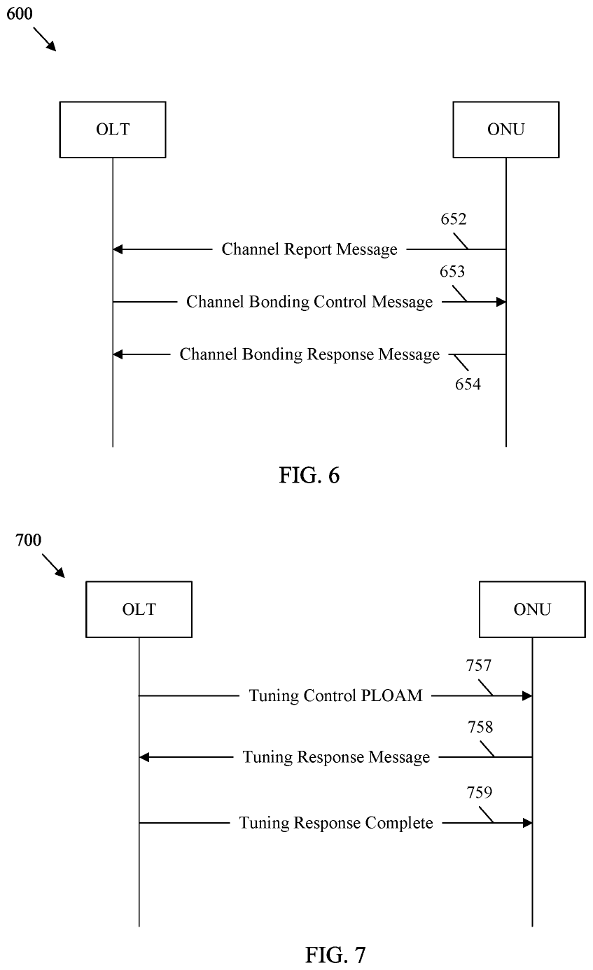

FIG. 6 is a protocol diagram illustrating another example mechanism 600 for bonding PON channels with PLOAM messages. For example, mechanism 600 can be employed to bond channels 331 in a PON 100 in order to support SDU 201 communication via division and transport in XGEM frames including XGEM headers 400. As discussed above, mechanism 500 includes channel bonding information in messages employed for other purposes during ONU registration with the OLT. In contrast, mechanism 600 employs a separate set of messages for the purpose of managing channel bonding by including channel availability and channel bonding assignments. Hence, mechanism 600 can be employed in conjunction with mechanism 500 by omitting channel bonding information from the messages of mechanism 500.

In mechanism 600, the ONU transmits a channel report message 652 containing channels that can be simultaneously employed by the ONU, and hence are available for channel bonding. The OLT then assigns channels and responds with a channel bonding control message 653 containing the channel bonding assignments. The ONU can then respond with a channel bonding response message 654, which acknowledges receipt of the channel bonding at the ONU. Specifically, a first PLOAM message (e.g., channel report message 652) can be transmitted from an upstream transceiver on the ONU and received by a downstream transceiver at the OLT. The first PLOAM message can be employed to indicate available channels for simultaneous upstream communication by the ONU and available channels for simultaneous downstream communication by the ONU. The OLT can then determine channels for channel bonding based on the available channels indicated by the ONU. A second PLOAM message (e.g., a channel bonding control message 653) can then be transmitted from the downstream transceiver on the OLT to the upstream transceiver on the OLT. The second PLOAM message can be employed to assign a plurality of bonded channels based on the available channels. The plurality of bonded channels can then be used for communication of a plurality of blocks from an SDU as discussed above.

The channel report message 652 can include a field for the purpose of indicating available channels for simultaneous upstream and downstream communication between the ONU and OLT. Such channels can be indicated via an upstream bitmap and a downstream bitmap. An example of a channel report message 652 containing a wavelength channel bitmap field to indicate available channels for bonding, is shown in Table 3 below.

TABLE 3
Channel Report message

| Octet | Content | Description |
|---|---|---|
| 1-2 | ONU-ID | 0x03 FF, Unassigned ONU-ID or ONU-ID of the message |
| | | sender. |
| 3 | Message type ID | 0x1D, “Channel_Report” |
| 4 | SeqNo | Set to 0x00 for all instances of Channel_Bonding_ONU |
| | | PLOAM message. |
| 5-8 | Vendor_ID | ONU Vendor-ID code, a four-character combination |
| | | discovered at ONU SN acquisition. |
| 9-12 | VSSN | Vendor-specific serial number, a four-byte unsigned integer |
| | | discovered at SN acquisition. |
| 13-14 | Downstream | A bitmap indexed by DWLCH ID; the MSB of octet 13 |
| | wavelength | correspond to DWLCH ID = 1111; the LSB of octet 14 |
| | channel | corresponds to DWLCH ID = 0000. The bit value of 1 |
| | capability | indicates that ONU supports the relative downstream |
| | | wavelength channel. |
| 15-16 | Upstream | A bitmap indexed by UWLCH ID; the MSB of octet 15 |
| | wavelength | correspond to UWLCH ID = 1111; the LSB of octet 16 |
| | channel | corresponds to UWLCH ID = 0000. The bit value of 1 |
| | capability | indicates that ONU supports the relative upstream wavelength |
| | | channel. |
| 17-40 | Padding | Set to 0x00 by the transmitter; treated as “don't care” by the |
| | | receiver. |
| 41-48 | MIC | Message integrity check computed using the default PLOAM |
| | | integrity key. |

The channel bonding control message 653 can include fields for the purpose of assigning bonded channels between the ONU and OLT based on the available channels indicated by the ONU. Such channels can be indicated via an upstream bitmap and a downstream bitmap. An example channel bonding control message 653 containing a downstream wavelength channel bonding set field and an upstream wavelength channel bonding set field to indicate assigned downstream and upstream bonded channels, respectively, is shown in Table 4 below.

TABLE 4
Channel Bonding Control message

| Octet | Content | Description |
|---|---|---|
| 1-2 | ONU-ID | Directed message to one ONU |
| 3 | Message type ID | 0x1D, “Channel_Bonding_Control”. |
| 4 | SeqNo | Eight-bit broadcast PLOAM sequence number. |
| 5 | Operation Code | 0x00: Request; All parameters are applicable |
| | | 0x01: Complete_d; Octet 6 are set to 0x00 by the OLT CT and |
| | | ignored by the ONU |
| 6 | Rollback flag | A bitmap of the form 0000 000R, where: |
| | | R - Rollback flag |
| | | R = 1: rollback available when setting fails; |
| | | R = 0: no rollback available when setting fails. |
| 7-8 | Downstream | A bitmap indexed by DWLCH ID; the MSB of octet 7 |
| | wavelength | correspond to DWLCH ID = 1111; the LSB of octet 8 |
| | channel bonding | corresponds to DWLCH ID = 0000. The bit value of 1 indicates |
| | set | that the relative downstream wavelength channel attends the |
| | | channel bonding. |
| 9-10 | Upstream | A bitmap indexed by UWLCH ID; the MSB of octet 9 |
| | wavelength | correspond to UWLCH ID = 1111; the LSB of octet 10 |
| | channel bonding | corresponds to UWLCH ID = 0000. The bit value of 1 indicates |
| | set | that the relative upstream wavelength channel attends the |
| | | channel bonding. |
| 11-40 | Padding | Set to 0x00 by the transmitter; treated as “don't care” by the |
| | | receiver. |
| 41-48 | MIC | Message integrity check, computed using the default PLOAM |
| | | integrity key. |

An example of a channel bonding response message 654 is also shown in Table 5 below.

TABLE 5
Channel Bonding Response message

| Octet | Content | Description |
|---|---|---|
| 1-2 | ONU-ID | ONU-ID of the message sender. |
| 3 | Message type ID | 0x1C, “Channel_Bonding_Response”. |
| 4 | SeqNo | Eight-bit unicast PLOAM sequence number. Repeats the value |
| | | from the downstream Channel_Bonding_Control PLOAM |
| | | message. |
| 5 | Operation code | Operation code: |
| | | 0x00: ACK; |
| | | 0x01: NACK; |
| | | 0x03: Complete_u; |
| | | 0x04: ROLLBACK. |
| | | Other values reserved. |
| 6 | Response code | Response code: |
| | | 0x00: As long as Operation code is ACK or Complete_u; |
| | | 0x01: NACK due to downstream wavelength being out of |
| | | supported; |
| | | 0x02: NACK due to upstream wavelength being out of |
| | | supported; |
| | | 0x03: NACK due to ONU not being ready to set channel |
| | | bonding; |
| | | 0x10: ROLLBACK due to one of wavelength channels failure. |
| | | Other values reserved. |
| 7-40 | Padding | Set to 0x00 by the transmitter; treated as “don't care” by the |
| | | receiver. |
| 41-48 | MIC | Message integrity check, computed using the default PLOAM |
| | | integrity key. |

FIG. 7 is a protocol diagram illustrating an example mechanism 700 for modifying a PON channel bonding with PLOAM messages. For example, mechanism 700 can be employed to modify bonded channels 331 in a PON 100 in order to support SDU 201 communication via division and transport in XGEM frames including XGEM headers 400. Specifically, an OLT may decide to recalibrate communication channels for an ONU, for example after performing mechanism 500 and/or 600. The OLT can transmit a Tuning control PLOAM message 757 to indicate prospective calibration changes to communication channels employed by the ONU. The ONU can then make the calibration changes and transmit a tuning response message 758 to the OLT in order to indicate that the calibration changes have been made. The OLT can then respond with a tuning response complete message 759 to acknowledge that the tuning response message 758 has been received and that the tuning process has been accomplished. As shown in Table 6 below, the tuning response message 758 can include fields for the purpose of the updating ONU channel bonding status with the OLT in light of the calibration changes. Specifically, octets 35-38 of the tuning response message 758 can contain a downstream wavelength channel bonding status field and an upstream wavelength channel bonding status field for updating the status of the bonded downstream channels and upstream channels, respectively.

TABLE 6
Tuning Response message

| Octet | Content | Description |
|---|---|---|
| 1-2 | ONU-ID | ONU-ID of the message sender |
| 3 | Message type ID | 0x1A, “Tuning_Response”. |
| 4 | SeqNo | Eight-bit unicast PLOAM sequence number. Repeats the value |
| | | from the downstream Tuning_Control PLOAM message. The |
| | | same value is used in Tuning_Response(acknowledgement |
| | | (ACK)) and subsequent Tuning_Response |
| | | (Complete_u/ROLLBACK) messages. |
| 5 | Operation code | Operation code: |
| | | 0x00: ACK; 0x01: non-acknowledgement (NACK); 0x03: |
| | | Complete_u; 0x04: ROLLBACK. Other values reserved. |
| 6-7 | Response code | Response code: |
| | | 0x0000: As long as Operation code is ACK or Complete_u. |
| | | Response codes reported with NACK operation code: |
| | | 0x0001: INT_SFC; 0x0002: DS_ALBL; 0x0004: DS_VOID; |
| | | 0x0008: DS_PART; 0x0010: DS_TUNR; 0x0020: DS_LNRT; |
| | | 0x0040: DS_LNCD; 0x0080: US_ALBL; 0x0100: US_VOID; |
| | | 0x0200: US_TUNR; 0x0400: US_CLBR; 0x0800: US_LKTP; |
| | | 0x1000: US_LNRT; 0x2000: US_LNCD. |
| | | Response codes reported with ROLLBACK operation code |
| | | (see Table 17-4 in clause 17.3.2 for the explanation of failure |
| | | conditions): |
| | | 0x0001: COM_DS; 0x0002: DS_ALBL; 0x0004: DS_LKTP; |
| | | 0x0008: US_ALBL; 0x0010: US_VOID; 0x0020: US_TUNR; |
| | | 0x0040: US_LKTP; 0x0080: US_LNRT; 0x0100: US_LNCD. |
| | | Other values reserved. |
| 7-10 | Vendor_ID | ONU Vendor-ID code, a four-character combination discovered at |
| | | ONU SN acquisition. |
| 11-14 | VSSN | Vendor-specific serial number, a four-byte unsigned integer |
| | | discovered at SN acquisition. |
| 15-16 | Correlation tag | Allows the ONU to associate OLT feedback in the form of |
| | | Calibration_Request or Adjust_Tx_Wavelength PLOAM message |
| | | with the specific transmitted message. |
| 17-20 | PON-ID | The PON-ID received by the ONU in its current downstream |
| | | wavelength channel. |
| 21 | UWLCH ID | An octet of the form 0000 UUUU, where: |
| | | UUUU - the UWLCH ID of the upstream wavelength channel in |
| | | which the ONU is transmitting. |
| 22-29 | Calibration | Reports ONU calibration record status in the course of activation |
| (TWDM) | record status | or upon handover. |
| 22-29 | SN Digest | A 64 bit value computed as a cryptographic hash over the publicly |
| (PtP | | available SN value and the shared secret Registration_ID: |
| WDM) | | Digest = AES-CMAC(Vendor_ID\|PON-ID\|VSSN\|PON-ID, |
| | | Registration_ID \| 0x50746F50697353696D706C65, 64). |
| 30 | Tuning | Represents the tuning granularity of the ONU transmitter as |
| | granularity | expressed in units of 1 gigahertz (GHz). |
| 31 | One-step tuning | Represents the value of the tuning time for a single granularity |
| | time | step as expressed in units of physical frames. |
| 32 | Upstream line | An indicator of ONU's upstream nominal line rate capability of |
| (TWDM) | rate capability | the form |
| | | 0000 00HL, where: |
| | | H - Upstream nominal line rate of 9.95328 Gbit/s: |
| | | H = 0: not supported; |
| | | H = 1: supported; |
| | | L - Upstream nominal line rate of 2.48832 Gbit/s: |
| | | L = 0: not supported; |
| | | L = 1: supported. |
| 32 | Upstream line rate | A bitmap of the form 0000 ABHL indicating the ONU's upstream |
| (PtP | capability | nominal line rate capability: |
| WDM) | | A - 6 Gbit/s rate class |
| | | B - 1 Gbit/s rate class |
| | | H - 10 Gbit/s rate class |
| | | L - 2.5 Gbit/s rate class |
| | | The bit value of 1 indicates that the respective rate class is |
| | | supported; the bit value of 0 indicates the respective rate class is |
| | | not supported. |
| 33 | Attenuation | Represents a requested attenuation level as a part of the power |
| | | levelling instruction to an ONU. |
| 34 | Power levelling | Power levelling capability is a seven-bit bitmap indicating that the |
| | capability | ONU supports attenuation levels. |
| 35-36 | Downstream | A bitmap indexed by DWLCH ID; the MSB of octet 35 |
| | wavelength | correspond to DWLCH ID = 1111; the LSB of octet 36 |
| | channel bonding | corresponds to DWLCH ID = 0000. The bit value of 1 indicates |
| | status | that the relative downstream wavelength channel is currently used |
| | | for channel bonding. |
| 37-38 | Upstream | A bitmap indexed by UWLCH ID; the MSB of octet 37 |
| | wavelength | correspond to UWLCH ID = 1111; the LSB of octet 38 |
| | channel bonding | corresponds to UWLCH ID = 0000. The bit value of 1 indicates |
| | status | that the relative upstream wavelength channel is currently used for |
| | | channel bonding. |
| 39-40 | Padding | Set to 0x00 by the transmitter; treated as “don't care” by the |
| | | receiver. |
| 41-48 | MIC | Message integrity check computed using the default PLOAM |
| | | integrity key. |

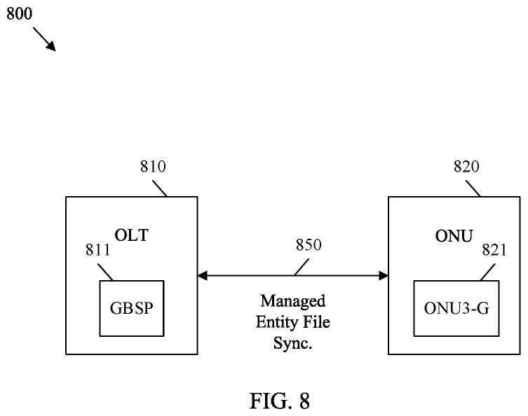

FIG. 8 is a schematic diagram illustrating an example mechanism 800 for bonding PON channels with managed entities. For example, mechanism 800 can be employed to bond channels 331 in a PON 100 in order to support SDU 201 communication via division and transport in XGEM frames including XGEM headers 400. Mechanism 800 can be employed alone or in conjunction with mechanisms 500, 600, and/or 700 to communicate channel bonding information.

Mechanism 800 operates on an OLT 810 and an ONU 820, which may be substantially similar to OLT 110 and ONU 120, respectively. The OLT 810 and an ONU 820 each control a managed entity, which share communication information including channel bonding information to support bonded channel communication as discussed above. The ONU 820 is configured to generate an ONU3-G managed entity 821. The OLT 810 is configured to generate an instance of a GBSP managed entity 811 for each ONU 820. The ONU3-G managed entity 821 and the GBSP managed entity 811 each store channel bonding information in local memory as a managed entity file. Hence, the ONU3-G managed entity 821 and the GBSP managed entity 811 each operate on a combination of processors and memory. Further, the ONU3-G managed entity 821 and the GBSP managed entity 811 are configured to synchronize 850 the managed entity file to ensure that both entities 811 and 821 have access to the same channel bonding information. Such synchronization 850 can occur periodically and/or upon the occurrence of a predefined condition (e.g., system software update, system reboot, system connect, channel tuning, etc.) Once the managed entity file is synchronized 850, the ONU3-G managed entity 821 and the GBSP managed entity 811 each store a local copy of the managed entity file in local memory. The synchronized 850 managed entity file may contain available channels for simultaneous upstream communication by the ONU 820, available channels for simultaneous downstream communication by the ONU 820, and/or assignments of bonded channels for upstream communication and downstream communication between the OLT 810 and ONU 820.

The ONU3-G managed entity 821 and the GBSP managed entity 811 are generated according to an ONU Management and Control Interface (OMCI) protocol. The ONU3-G managed entity 821 is a control and management entity that manages and controls communications for the ONU 820. For example, the ONU3-G managed entity 821 controls the ONU 820 upstream transceiver to direct sampling of the communication stream from the OLT 810 to obtain relevant data, controls the ONU 820 upstream transceiver to transmit data upstream at an appropriate time slot, directs packets toward corresponding communication ports, etc. The GBSP managed entity 811 is a control and management entity that manages a corresponding ONU3-G managed entity 821 based on network wide time slot assignments.

The ONU3-G managed entity 821 can be configured according to Table 7 to manage channel bonding at the ONU 820. It should be noted that the functionality of Table 7 could also be added to other managed entities at an ONU 820 to accomplish channel bonding in some examples.

TABLE 7
ONU3-G

| ONU3-G | This managed entity contains additional attributes associated with a PON | |
|---|---|---|
| | ONU. The ONU automatically creates an instance of this managed entity. Its | |
| | attributes are populated according to data within the ONU itself. | |
| Relationships | This managed entity is paired with the ONU-G and ONU2-G entity. | |
| Attribute | This attribute uniquely identifies each instance of this managed entity. | |
| Managed entity | There is only one instance, number 0. (R) (2 bytes). | |
| ID | | |
| Attribute | This attribute uniquely identifies the ONU's downstream wavelength | |
| Downstream | channel bonding capability. It's a bit map that defines whether the related | |
| wavelength | wavelength channels are capable of channel bonding or not. Bits are | |
| channel bonding | assigned as follows: | |
| capability | BIT | Meaning |
| | 1(LSB) | Set 1 means Wavelength channel 0 supports channel bonding |
| | 2 | Set 1 means Wavelength channel 1 supports channel bonding |
| | . . . | |
| | 16 | Set 1 means Wavelength channel 15 supports channel bonding |
| | (W) (2 bytes) | |
| Attribute | This attribute uniquely identifies the ONU's upstream wavelength channel | |
| Upstream | bonding capability. It's a bit map that defines whether the related wavelength | |
| wavelength | channels are capable of channel bonding or not. Bits are assigned as follows: | |
| channel bonding | BIT | Meaning |
| capability | 1(LSB) | Set 1 means Wavelength channel 0 supports channel bonding |
| | 2 | Set 1 means Wavelength channel 1 supports channel bonding |
| | . . . | |
| | 16 | Set 1 means Wavelength channel 15 supports channel bonding |
| | | (W) (2 bytes) |
| Attribute | This attribute uniquely identifies the ONU's downstream wavelength channel | |
| Downstream | bonding status. It's a bit map that defines whether the related wavelength | |
| wavelength | channels are used for channel bonding or not. Bits are assigned as follow: | |
| channel bonding | BIT | Meaning |
| status | 1(LSB) | Set 1 means Wavelength channel 0 used for channel bonding |
| | 2 | Set 1 means Wavelength channel 1 used for channel bonding |
| | . . . | |
| | 16 | Set 1 means Wavelength channel 15 user for channel bonding |
| | (W) (2 bytes) | |
| Attribute | This attribute uniquely identifies the ONU's upstream wavelength channel | |
| Upstream | bonding status. It's a bit map that defines whether the related wavelength | |
| wavelength | channels are used for channel bonding or not. Bits are assigned as follow: | |
| channel bonding | BIT | Meaning |
| status: | 1(LSB) | Set 1 means Wavelength channel 0 used for channel bonding |
| | 2 | Set 1 means Wavelength channel 1 used for channel bonding |
| | . . . | |
| | 16 | Set 1 means Wavelength channel 15 used for channel bonding |
| | (W) (2 bytes) | |

| | |
|---|---|
| Actions | Create, get |

The above OMCI extensions are for channel bonding configuration. After such configuration, the bonded units are encapsulated into XGEM frames for distribution to and transmission over multiple physical (PHY) interfaces of an ONU 820 or the OLT 810. This updates the relationship between a GEM Interworking Termination Point (TP) at the OLT 810 and a GEM port network Connection Termination Point (CTP) at the ONU 820 in the OMCI protocol. The TP and the CTP act as communication points so that upper layer processes can treat PON communications as if they were point to point communications. Multiple GEM port network CTPs at multiple ONUs 820 may point to a GEM Interworking TP instance at the OLT 810. Toward this end, the GBSP managed entity 811 can be designed as described in Table 8.

TABLE 8
GBSP

| GBSP | This managed entity organizes data associated with a channel bonding group. | |
|---|---|---|
| | The OLT creates one instance of this managed entity for each channel bonding | |
| | group. | |
| Relationships | One instance of this managed entity exists for each channel bonding. As | |
| | instance of this managed entity is associated with one or more instances of | |
| | GEM Port Network CTP. An instance of this managed entity is associated with | |
| | one instance of GEM Internetworking TP. | |
| Attribute | This attribute uniquely identifies each instance of this managed entity. Its | |
| Managed entity | value is created by the OLT. (R) (2 bytes) | |
| ID | | |
| Attribute | This attribute uniquely identifies the downstream wavelength channel bonding | |
| Downstream | configuration. It's a bit map that defines whether the related wavelength | |
| wavelength | channel attends channel bonding or not. Bits are assigned as follows: | |
| channel | BIT | Meaning |
| bonding set | 1(LSB) | Set 1 means Wavelength channel 0 attend the channel bonding |
| | 2 | Set 1 means Wavelength channel 1 attend the channel bonding |
| | . . . | |
| | 16 | Set 1 means Wavelength channel 15 attend the channel bonding |
| | (W) (2 bytes) | |
| Attribute | This attribute uniquely identifies the upstream wavelength channel bonding | |
| Upstream | configuration. It's a bit map that define whether the related wavelength | |
| wavelength | channels attends channel bonding or not. Bits are assigned as follow: | |
| channel | BIT | Meaning |
| bonding set | 1(LSB) | Set 1 means Wavelength channel 0 attend the channel bonding |
| | 2 | Set 1 means Wavelength channel 1 attend the channel bonding |
| | . . . | |
| | 16 | Set 1 means Wavelength channel 15 attend the channel bonding |
| | (W) (2 bytes) | |

| | |
|---|---|
| Actions | Create, delete, get, set |

An instance of the GEM Bonding Service Profile works as the hub to connect multiple GEM port network CTP instances at the ONUs 820 and a GEM Interworking TP instance at the OLT 810. A pointer should be added to the GEM Interworking TP. The pointer points to the corresponding GBSP managed entity 811 instance. Another pointer should be added to the GEM port network CTP at the ONU 820. The pointer also points to the same GBSP managed entity 811 instance. In scenarios of channel bonding, multiple GEM port network CTP instances are created for an ONU 820, and their associated GEM port IDs are the same. The outgoing XGEM frames are generated by the GEM Interworking TP instance and the incoming XGEMs are reassembled by the GEM Interworking TP instance. Table 9 shows the added GBSP pointer in the GEM Port Network CTP managed entity at the ONU 820.

TABLE 9
GEM Port Network CTP

| | |
|---|---|
| GEM | Other definition and attributes in GEM Port |
| Port Network | Network CTP managed entity (ME) per OMCI protocol |
| CTP | |
| Attribute | This attribute points to an instance of the GBSP ME. |
| GBSP ID | (R, W, Set-by-create) (optional) (2 bytes) |
| pointer | |

Table 10 shows the added GBSP pointer in the GEM Internetworking TP managed entity as used at the OLT 810.

TABLE 10
GEM Internetworking TP

| | |
|---|---|
| GEM | Other definition and attributes in GEM |
| Internetworking | Internetworking TP ME per OMCI protocol |
| TP | |
| Attribute | This attribute points to an instance of the GBSP |
| GBSP ID | ME. (R, W, Set-by-create) (optional) (2 bytes) |
| pointer | |

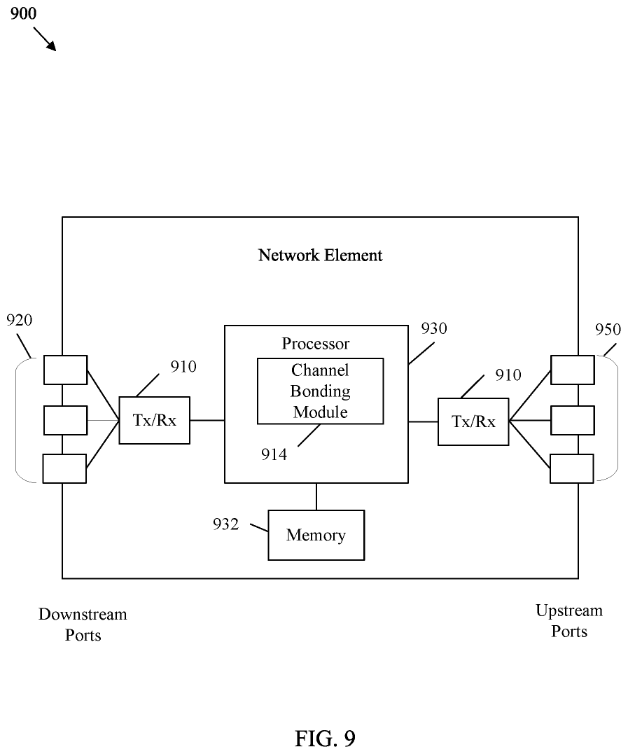

FIG. 9 is a schematic diagram of an example network element 900 for use in a PON, such as PON 100. For example, the network element 900 can be employed to implement an OLT 110, OLT 810, ONU 120, and/or ONU 820. The network element 900 can be employed to bond channels 331, by employing mechanisms 500, 600, 700, and/or 800. The network element 900 can then employ scheme 200 to divide an SDU into blocks and encapsulate such blocks in XGEM frames, including XGEM headers 400, for transmission over bonded channels per protocol 300. The network element 900 is also suitable for implementing any other disclosed embodiments/examples as described herein. The network element 900 comprises downstream ports 920, upstream ports 950, and/or transceiver units (Tx/Rx) 910 for communicating data upstream and/or downstream over a network, such as a PON 100. The Tx/Rx 910 can act as upstream and downstream receivers, transmitters, and/or transceivers, depending on the example. The network element 900 also includes a processor 930 including a logic unit and/or central processing unit (CPU) to process the data and a memory 932 for storing the data. The network element 900 may also comprise optical-to-electrical (OE) components and/or electrical-to-optical (EO) components coupled to the upstream ports 950 and/or downstream ports 920 for communication of data via optical communication networks.

The processor 930 is implemented by hardware and software. The processor 930 may be implemented as one or more CPU chips, cores (e.g., as a multi-core processor), field-programmable gate arrays (FPGAs), application specific integrated circuits (ASICs), and digital signal processors (DSPs). The processor 930 is in communication with the downstream ports 920, Tx/Rx units 910, upstream ports 950, and memory 932. The processor 930 comprises a channel bonding module 914. The channel bonding module 914 implements the disclosed embodiments described herein, such as scheme 200, protocol 300, and mechanisms 500, 600, 700, and/or 800. The channel bonding module 914 may also encapsulate SDU blocks with XGEM headers 400. For example, the channel bonding module 914 may perform channel bonding via PLOAM messages and/or managed entities. The channel bonding module 914 may then subdivide SDUs according to scheme 200, encapsulate the blocks in a XGEM frames, and communicate the blocks according to protocol 300. The inclusion of the channel bonding module 914 therefore provides a substantial improvement to the functionality of the network element 900 and effects a transformation of the network element 900 to a different state. Alternatively, the channel bonding module 914 can be implemented as instructions stored in the memory 932 and executed by the processor 930 (e.g., as a computer program product stored on a non-transitory medium).

The memory 932 comprises one or more memory types such as disks, tape drives, solid-state drives, read only memory (ROM), random access memory (RAM), flash memory, ternary content-addressable memory (TCAM), static random-access memory (SRAM), etc. The memory 932 may be used as an over-flow data storage device, to store programs when such programs are selected for execution, and to store instructions and data that are read during program execution.

In an example embodiment, the network element 900 includes a reception module receiving a downstream Service Data Unit (SDU) including user data at an upstream transceiver, a splitter module splitting the downstream SDU into a plurality of downstream blocks, a distribution module distributing the downstream blocks amongst a plurality of bonded channels, with the distributing being based on bonded channel availability, and a transmission module transmitting the downstream blocks over a Passive Optical Network (PON) via the plurality of bonded channels. In some embodiments, the network element 900 may include other or additional modules for performing any one of or combination of steps described in the embodiments. Further, any of the additional or alternative embodiments or aspects of the method, as shown in any of the figures or recited in any of the claims, are also contemplated to include similar modules.

In an example embodiment, the network element 900 includes a reception module receiving a plurality of downstream blocks distributed amongst a plurality of bonded channels, with the distributing being based on channel availability, a reassembler module reassembling the plurality of downstream blocks received from the plurality of bonded channels over the PON into a downstream Service Data Unit (SDU) including user data, and a forward module forwarding the downstream SDU toward a user via a downstream interface. In some embodiments, the network element 900 may include other or additional modules for performing any one of or combination of steps described in the embodiments. Further, any of the additional or alternative embodiments or aspects of the method, as shown in any of the figures or recited in any of the claims, are also contemplated to include similar modules.

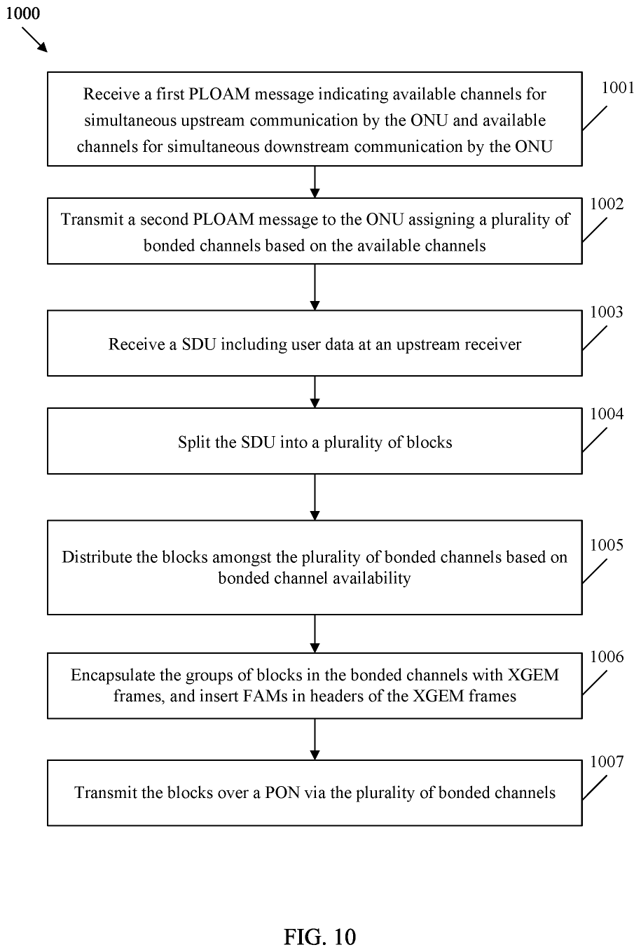

FIG. 10 is a flowchart of an example method 1000 of transmitting data over bonded channels in a PON. For example, method 1000 can be implemented in an OLT 110, an OLT 810, and/or a network element 900. Further, method 1000 is an example implementation of scheme 200, protocol 300, and/or mechanisms 500, 600, 700, and/or 800. In addition, method 1000 can employ XGEM headers 400.

The method 1000 initiates when an ONU joins a PON. The ONU then registers with the OLT. During this process, a first PLOAM message is received at a downstream transceiver of an OLT at step 1001. The first PLOAM message is received from the ONU and indicates available channels for simultaneous upstream communication by the ONU and available channels for simultaneous downstream communication by the ONU. Depending on the example, the first PLOAM message may be a Serial Number ONU message, a Channel Report message, or a Tuning Response message.

At step 1002, the OLT transmits a second PLOAM message to the ONU in response to the first PLOAM message of step 1001. The second PLOAM message assigns a plurality of bonded channels for further communication based on the available channels. Specifically, the plurality of bonded channels are later employed for communication of a plurality of blocks split from an SDU. Depending on the example, the second PLOAM message can be an Assign ONU ID message or a Channel Bonding Response message.

It should be noted that when mechanism 800 is employed, steps 1001 and 1002 can be omitted in place of a block that generates a GBSP managed entity to synchronize a managed entity file with an ONU3-G managed entity operating at the ONU, and stores the managed entity file in the memory. In this case, the managed entity file includes the available channels for simultaneous upstream communication by the ONU, the available channels for simultaneous downstream communication by the ONU, and the bonded channels for upstream communication and downstream communication between the OLT and ONU.

In either case, channels become bonded upon completion of the preceding steps. At step 1003, an SDU including user data is received at an upstream receiver/transceiver. The SDU may be an Ethernet packet/frame, or other communications packet. At step 1004, the SDU is split into a plurality of blocks for transmission over the bonded channels. The blocks split from the SDU may be split to include eight bytes of user data each.

The blocks are then distributed amongst the plurality of bonded channels based on bonded channel availability at step 1005. For example, distributing the blocks amongst the bonded channels based on bonded channel availability may include evenly distributing the blocks over each available bonded channel at each transmitter buffer index. Groups of the blocks can then be encapsulated in the bonded channels with XGEM frames at step 1006 prior to transmission over the PON. To support reordering the blocks at an ONU upon receipt over the selected bonded channels, FAMs can be inserted into headers of the XGEM frames. For example, the FAMs may include transmitter buffer indices employed by a transmitter buffer for the corresponding XGEM frames. The blocks are then transmitted over the PON via the plurality of bonded channels at step 1007.

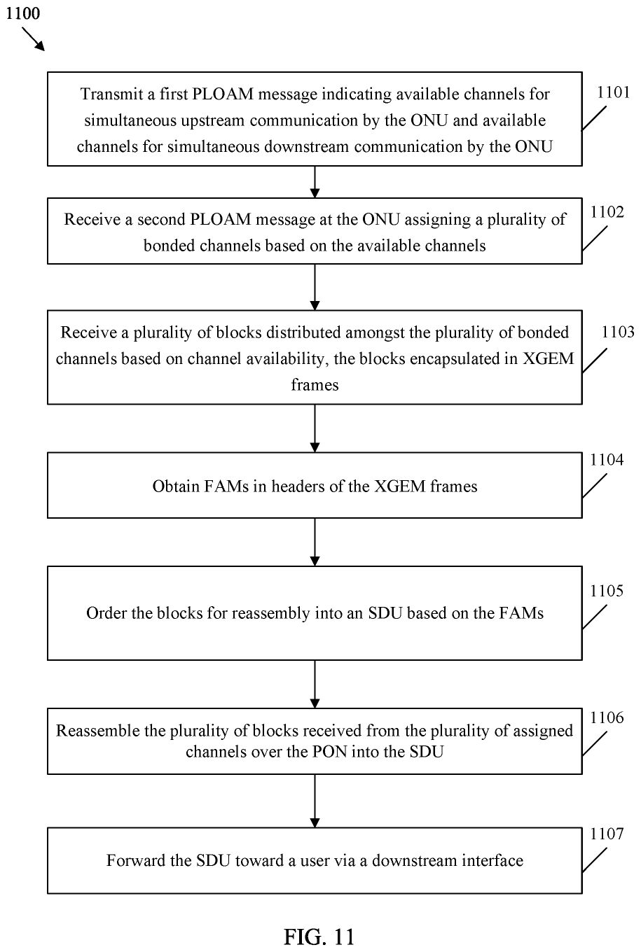

FIG. 11 is a flowchart of an example method 1100 of receiving data over bonded channels in a PON. For example, method 1100 can be implemented in an ONU 120, an ONU 820, and/or a network element 900. Further, method 1100 is an example implementation of scheme 200, protocol 300 and/or mechanisms 500, 600, 700, and/or 800. In addition, method 1100 can employ XGEM headers 400.

The method 1100 initiates when an ONU joins a PON. The ONU then registers with the OLT. During this process, the ONU transmits a first PLOAM message to the OLT at step 1101. The first PLOAM message indicates available channels for simultaneous upstream communication by the ONU and available channels for simultaneous downstream communication by the ONU. Depending on the example, the first PLOAM message can be a Serial Number ONU message, a Channel Report message, or a Tuning Response message.

At step 1102, the ONU receives a second PLOAM message from the OLT. The second PLOAM message assigns a plurality of bonded channels based on the available channels of step 1101. The plurality of bonded channels can then be used for communication of a plurality of blocks of an SDU. Depending on the example, the second PLOAM message can be an Assign ONU ID message or a Channel Bonding Response message.

It should be noted that when mechanism 800 is employed, steps 1101 and 1102 can be omitted in place of a block that generates an ONU3-G managed entity configured to synchronize a managed entity file with a GBSP managed entity instance operating on the OLT, and storing the managed entity file in memory. In this case, the managed entity file includes available channels for simultaneous upstream communication by the ONU, available channels for simultaneous downstream communication by the ONU, and bonded channels for upstream communication and downstream communication between the OLT and ONU.

In either case, channels become bonded upon completion of the preceding steps. At step 1103, a plurality of blocks are received at the ONU (e.g., from the OLT). Such blocks are distributed amongst a plurality of bonded channels based on channel availability. The blocks can be distributed equally amongst the bonded channels available at each transmitter buffer index in some examples. Further, the plurality of blocks can be received in XGEM. For example, each XGEM frame can encapsulate a group of blocks in a common bonded channel. In some examples, the blocks may include eight bytes of user data each.

At step 1104, FAMs in headers of the XGEM frames are obtained. The blocks can then be ordered for reassembly into an SDU based on the FAMs at step 1105. In some cases, the FAMs are transmitter buffer indices employed by an OLT transmitter buffer for the corresponding XGEM frames.

At step 1106, the blocks received from the plurality of bonded channels over the PON are reassembled into an SDU including user data. The SDU can then be forwarded toward a user via a downstream interface at step 1107.

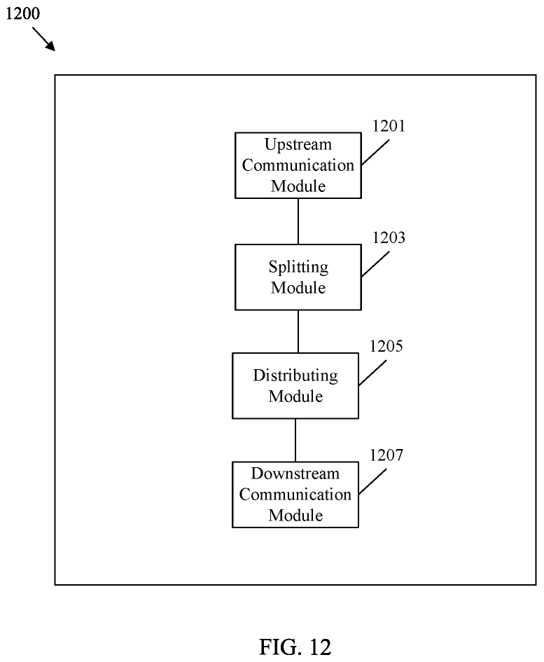

FIG. 12 is an embodiment of a device 1200 for communicating data over bonded channels in a PON. For example, device 1200 can be implemented by an OLT 110, an OLT 810, an ONU 120, an ONU 820, and/or a network element 900. Further, device 1200 can be employed to implement scheme 200, protocol 300 and/or mechanisms 500, 600, 700, and/or 800. In addition, device 1200 can employ XGEM headers 400. The device 1200 includes an upstream communication module 1201 configured for receiving a SDU including user data. The device 1200 also includes a splitting module 1203 for splitting the SDU into a plurality of blocks. The device 1200 also includes a distributing module 1205 for distributing the blocks amongst a plurality of bonded channels based on bonded channel availability. The device 1200 also includes a downstream communication module 1207 for transmitting the blocks over a PON via the plurality of bonded channels. The modules of device 1200 can also be employed to implement steps 1001, 1002, 1003, 1004, 1005, 1006, and/or 1007 of method 1000. The modules of device 1200 can also be employed to implement steps 1101, 1102, 1103, 1104, 1105, 1106, and/or 1107 of method 1100.

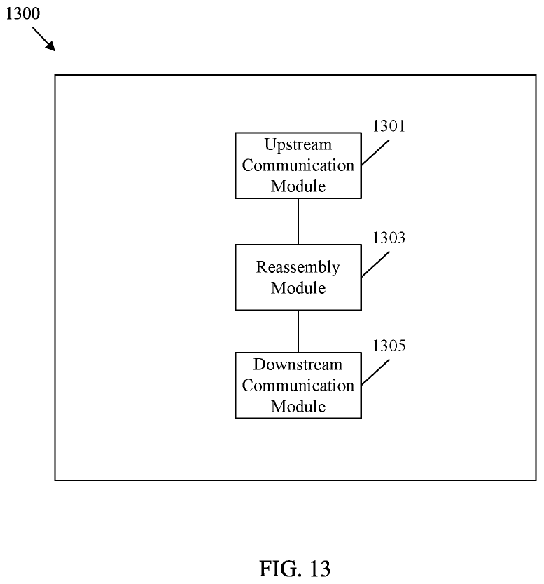

FIG. 13 is an embodiment of another device 1300 for communicating data over bonded channels in a PON. For example, device 1300 can be implemented in an OLT 110, an OLT 810, an ONU 120, an ONU 820, and/or a network element 900. Further, device 1300 can be employed to implement scheme 200, protocol 300 and/or mechanisms 500, 600, 700, and/or 800. In addition, device 1300 can employ XGEM headers 400. The device 1300 includes an upstream communication module 1301 for receiving a plurality of blocks from a PON, where the plurality of blocks are distributed amongst a plurality of bonded channels based on channel availability. The device 1300 also includes a reassembly module 1303 for reassembling the plurality of blocks received from the plurality of bonded channels over the PON into a SDU including user data. The device 1300 also includes a downstream communication module 1305 for forwarding the SDU toward a user via a downstream interface. The modules of device 1300 can also be employed to implement steps 1001, 1002, 1003, 1004, 1005, 1006, and/or 1007 of method 1000. The modules of device 1300 can also be employed to implement steps 1101, 1102, 1103, 1104, 1105, 1106, and/or 1107 of method 1100.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other examples of changes, substitutions, and alterations are ascertainable by one skilled in the art and may be made without departing from the spirit and scope disclosed herein.

What is claimed is:

1. An Optical Line Terminal (OLT) comprising:
a downstream transceiver coupled to a Passive Optical Network (PON), the downstream transceiver configured to communicate over a plurality of bonded channels;
an upstream transceiver configured to receive a downstream Service Data Unit (SDU), the downstream SDU including user data; and
a processor coupled to the upstream transceiver and to the downstream transceiver, the processor configured to:
split the downstream SDU into a plurality of downstream blocks; and
distribute the downstream blocks amongst selected bonded channels, with the distributing being based on bonded channel availability for transmission over the PON via the downstream transceiver.

2. The OLT of claim 1, wherein distributing the plurality of downstream blocks amongst the selected bonded channels based on bonded channel availability includes evenly distributing the plurality of downstream blocks over each available bonded channel at each transmitter buffer index.

3. The OLT of claim 1, wherein the processor is further configured to employ ten-Gigabit PON Encapsulation Mode (XGEM) frames to encapsulate groups of downstream blocks in the selected bonded channels prior to transmission over the PON.

4. The OLT of claim 3, wherein the processor is further configured to insert Frame Alignment Markers (FAMs) in headers of the XGEM frames to support ordering the plurality of downstream blocks at an Optical Network Unit (ONU) upon receipt of the plurality of downstream blocks over the selected bonded channels.

5. The OLT of claim 4, wherein the downstream transceiver includes a transmitter with a transmitter buffer, and wherein the FAMs are transmitter buffer indices employed by the transmitter buffer for the corresponding XGEM frames.

6. The OLT of claim 4, wherein the downstream transceiver is configured to receive a first Physical Layer Operations, Administration, and Maintenance (PLOAM) message from the ONU, the first PLOAM message indicating available channels for simultaneous upstream communication by the ONU and available channels for simultaneous downstream communication by the ONU.

7. The OLT of claim 6, wherein the downstream transceiver is configured to transmit a second PLOAM message to the ONU, the second PLOAM message assigning the selected bonded channels based on the bonded channel availability, the selected bonded channels being assigned for communication of the plurality of downstream blocks from the downstream SDU.

8. The OLT of claim 7, wherein the first PLOAM message is a Serial Number ONU message, a Channel Report message, or a Tuning Response message, and wherein the second PLOAM message is an Assign ONU Identifier (ID) message or a Channel Bonding Response message.

9. The OLT of claim 4, further comprising a memory, wherein the processor is further configured to generate a Gigabit PON Encapsulation (GEM) Bonding Service Profile (GBSP) managed entity instance for the ONU, the GBSP managed entity configured to synchronize a managed entity file with an ONU Three Gigabit (ONU3-G) managed entity operating at the ONU, and store the managed entity file in the memory, the managed entity file including:
available channels for simultaneous upstream communication by the ONU;
available channels for simultaneous downstream communication by the ONU; and
bonded channels for upstream communication and downstream communication between the OLT and ONU.

10. The OLT of claim 1, wherein the downstream transceiver is further configured to receive a plurality of upstream blocks distributed amongst second selected bonded channels based on bonded channel availability, and wherein the processor is further configured to:
reassemble the plurality of upstream blocks received from the second selected bonded channels over the PON into an upstream SDU, the upstream SDU including user data; and
forward the upstream SDU via the upstream transceiver.

11. An Optical Network Unit (ONU) comprising:
a transceiver coupled to a Passive Optical Network (PON), the transceiver configured to:
communicate over the PON via a plurality of bonded channels; and
receive a plurality of downstream blocks distributed amongst selected bonded channels, with the distributing being based on bonded channel availability;
a processor coupled to the transceiver, the processor configured to:
reassemble the plurality of downstream blocks received from the selected bonded channels over the PON into a downstream Service Data Unit (SDU), the downstream SDU including user data; and
forward the downstream SDU toward a user device via a downstream interface.

12. The ONU of claim 11, wherein the plurality of downstream blocks are distributed equally amongst the selected bonded channels available at each transmitter buffer index.

13. The ONU of claim 11, wherein the plurality of downstream blocks are received in ten-Gigabit PON Encapsulation Mode (XGEM) frames, each XGEM frame encapsulating a group of downstream blocks in a common bonded channel.

14. The ONU of claim 13, wherein the processor is further configured to:
obtain Frame Alignment Markers (FAMs) in headers of the XGEM frames; and
order the plurality of downstream blocks for reassembly into the downstream SDU based on the FAMs.

15. The ONU of claim 14, wherein the FAMs are transmitter buffer indices employed by an Optical Line Terminal (OLT) transmitter buffer for the corresponding XGEM frames.

16. The ONU of claim 11, wherein the transceiver is configured to transmit a first Physical Layer Operations, Administration, and Maintenance (PLOAM) message to an OLT, the first PLOAM message indicating available channels for simultaneous upstream communication by the ONU and available channels for simultaneous downstream communication by the ONU.

17. The ONU of claim 16, wherein the transceiver is configured to receive a second PLOAM message from the OLT, the second PLOAM message assigning the selected bonded channels based on the bonded channel availability, the selected bonded channels being assigned for communication of the plurality of downstream blocks of the downstream SDU.

18. The ONU of claim 17, wherein the first PLOAM message is a Serial Number ONU message, a Channel Report message, or a Tuning Response message, and wherein the second PLOAM message is an Assign ONU Identifier (ID) message or a Channel Bonding Response message.

19. The ONU of claim 11, further comprising a memory coupled to the processor, wherein the processor is further configured to generate an ONU Three Gigabit (ONU3-G) managed entity configured to synchronize a managed entity file with a Gigabit PON Encapsulation (GEM) Bonding Service Profile (GBSP) managed entity instance operating on an OLT, and store the managed entity file in the memory, the managed entity file including:
available channels for simultaneous upstream communication by the ONU;
available channels for simultaneous downstream communication by the ONU; and
bonded channels for upstream communication and downstream communication between the OLT and ONU.

20. The ONU of claim 11, wherein the downstream interface is further configured to receive an upstream SDU, the upstream SDU including user data, and wherein the processor is further configured to:
split the upstream SDU into a plurality of upstream blocks; and
distribute the plurality of upstream blocks amongst second selected bonded channels based on bonded channel availability for transmission over the PON via the transceiver.
